(19) United States
(12) Patent Application Publication
(10) Pub. No.: US 2002/0013729 A1
(43) Pub. Date: Jan. 31, 2002

(54) Advertisement presentation system

(75) Inventor: Koji Kida, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION.

(21) Appl. No.: 09/916,581

(22) Filed: Jul. 30, 2001

(30) Foreign Application Priority Data
Jul. 31, 2000 (JP) 231632/2000

(51) Int. Cl. G06F 17/60

(52) U.S. Cl. 705/14

(57) ABSTRACT

An interest estimation means is provided for estimating, from user schedule information, what users are currently interested in. Advertisements that accord with distribution conditions—which are based on these estimated user interests—are selected, and these advertisements are presented along with schedule information. In addition to user interests, the advertisement distribution conditions can include user whereabouts, and what advertisements a user has incorporated into his own schedule information.

### BACKGROUND OF THE INVENTION

1. Field of the Invention

The present invention relates to a system—for use in a schedule management service for managing the schedules of individual users—that presents advertisements which relate to users' schedules. This invention can be utilized in systems that use networks to distribute advertisements. The invention also relates to a schedule and advertisement presentation system capable of distributing advertisements that are appropriate to the schedules, interests and preferences of individual users. It also relates to a storage medium in which is stored software for implementing this system.

2. Description of Related Art

An important task for publicity and marketing via a homepage on the Internet is to find a way of getting a greater number of ordinary users to visit the homepage in question. A common way of trying to achieve this is to display, on other homepages, advertisements (e.g., banner advertisements) that are linked to the target homepage. The following ways have been devised to get a higher proportion of users to click on a target banner advertisement.

1) Conventional Method 1: present a more eye-catching banner advertisement. Increase the click rate by using a technique such as animation to catch the attention of more users.

2) Conventional Method 2: present advertisements that are related to the contents of the homepage. Increase the click rate by having a homepage carry an advertisement which users who visit that homepage are likely to find interesting. For example, a homepage that offers travel-related information can carry a banner advertisement for a travel agent.

3) Conventional Method 3: let user actions determine which advertisements will be displayed. Display banner advertisements in accordance with a keyword that a user has input in a search, as in the case of World Wide Web portal services (e.g., Yahoo). This facilitates preferential display of advertisements that are of interest to a user, so that a higher click rate can be expected.

Meanwhile, users want a simple method for collecting information (e.g., advertisements) in which they are interested. Currently, the following methods are commonly employed.

4) Conventional Method 4: collect information by subscribing to an e-mail magazine whereby e-mail articles relating to areas of interest to the user are sent at regular intervals.

5) Conventional Method 5: use a search service such as Yahoo to search when necessary.

However, the following problems are encountered with banner advertisements that utilize these conventional techniques.

From the point of view of the user, most banner advertisements are of no interest, and hence a user acquires the habit of not looking at banner advertisements. Conventional Method 1 tries to solve this problem by making the banner advertisement conspicuous. Nevertheless, users will not click on information in which they are not interested, no matter how often it is presented. Another problem is that banner advertisements can make it difficult to read the homepage that the user is primarily interested in. On the other hand, although Conventional Methods 2 and 3 are approaches that attempt to present advertisements that the user is likely to find interesting, the problem here is that these methods can only provide a rough match with users' interests. From the point of view of the advertising sponsor, it would be desirable to be able to specify the user group so that the sponsor's advertisement could be displayed to more suitable users. For example, an advertiser might want to present an advertisement targeted at women in their twenties, but this would be impossible using Conventional Methods 2 or 3.

An advertiser also has to analyze the effect of advertisements in order to devise more efficient marketing strategies. However, with Conventional Methods 1, 2 and 3, feedback to the advertising sponsor is limited to information relating to the number of clicks, and therefore only rough analysis is possible. If, by way of example, the age group of a person who has clicked a sponsor's advertisement could be used as feedback, then it would be possible to ensure that the next time that homepage was accessed by the user it would carry an advertisement that was in accord with his age group. It is therefore essential to have a mechanism for feeding back the effect of an advertisement to the advertising sponsor. However, users are reluctant to let personal information such as their address and age become known to advertisers, and so some method that allows the advertiser to receive feedback while protecting user privacy is essential.

Meanwhile, the following problems are encountered with the information (i.e., advertisement) collection methods provided by Conventional Methods 4 and 5.

Namely, if a user has adopted Conventional Method 4 in order to collect information (advertisements) in which he is interested, he simply receives information that has been sent unilaterally at the article writer's convenience, and hence it can be difficult for the user to obtain timely information. For example, if you have to buy a present this month for your child's birthday and have pre-registered an interest in information relating to special deals, bargains, etc., available on children's toys, you are still not guaranteed to receive articles in time.

In the case of Conventional Method 5, the user is given the responsibility of conducting searches at regular intervals, and it is troublesome to have to search each month, for example, for information on when a book or a CD will go on sale or when a film will be shown.

### SUMMARY OF THE INVENTION

The present invention has been devised in the light of the aforementioned problems. It is therefore an object of the invention to provide an advertisement presentation system that enables the advertiser to distribute advertisements to more suitable users, and that has a mechanism for feeding back, to the advertiser, the sort of user who has clicked on the advertisement, so that the advertiser can evaluate the effect of the advertising. It is a further object of the invention to provide an advertisement presentation system that enables users to collect, in a timely manner, advertisements in which they themselves are interested.

The present invention comprises user schedule information storage means for storing user schedule information; advertisement data storage means for storing advertisements to be presented in conjunction with schedule information when a user consults his schedule information; interest estimation means for estimating, from the user schedule information stored in the user schedule information storage means, which advertisements a user will be interested in; and advertisement presentation means for presenting to a user, along with the user's schedule information, advertisements that the interest estimation means has estimated will be interesting to the user.

By estimating, from a user's schedule information in a schedule management service, which advertisements are likely to be of interest to the user, this invention can present the user with interesting data without the user having to consciously select this data. Accordingly, from the advertiser's point of view the invention provides more effective advertising, and from the user's point of view it presents advertisements that are related to his own schedule.

The aforementioned interest estimation means can include means for consulting a knowledge database in which has been stored information relating to what sort of advertising service a certain schedule item corresponds with, and for extracting, from the user's schedule information, a keyword for retrieving the associated advertisement data; and the aforementioned advertisement presentation means can include means for using the keyword extracted by the interest estimation means to associate advertisement data that matches the keyword with user schedule information, and for presenting this advertisement data along with the user schedule information.

Interest can be estimated by providing a knowledge database containing information relating to what schedule items (i.e., events) are associated with what sort of advertisements, consulting this knowledge database, searching for and extracting the advertisement data that corresponds with a user's schedule information, and establishing an association between schedule information and advertisements.

The aforementioned advertisement data storage means can also store geographical region data serving as a condition for presenting an advertisement, and a user whereabouts estimation means can be provided for estimating, from the user's schedule information in the user schedule information storage means, which geographical region the user is currently in. The aforementioned advertisement presentation means can include means for associating advertisement data that corresponds to this estimated user whereabouts with a user's schedule information, and for presenting it along with the schedule information. A further improvement in advertising effectiveness can be expected if, in addition to estimating the user's interests, his whereabouts are taken into consideration when searching for and extracting appropriate advertisements for presenting to the user.

The invention can include means for storing as user schedule information in the user schedule storage means, as a result of user input, advertisement data that has been presented along with user schedule information; and the interest estimation means can include means for estimating, from this advertisement data stored as schedule information, which advertisements the user will find interesting.

When a user has incorporated advertisement data into his own schedule information, this advertisement data can be considered to be an item that the user is interested in. Accordingly, if advertisements related to this incorporated advertisement are subsequently presented, more effective advertising can be expected. Moreover, because relevant advertisements are being presented, the system offers greater amenity to the user.

An advertisement presentation system according to the present invention can be implemented as a system comprising a server and user terminals connected via a network. According to another aspect, this invention is a server to which user terminals are connected via a network, this server comprising: user schedule information storage means for storing user schedule information that has been input from the user terminals; schedule output means for outputting user schedule information from the user schedule information storage means when there has been an access from a user terminal; advertisement data storage means for storing advertisement data that has been input from an advertising provider; and means for associating the advertisement data stored in this advertisement data storage means with the user schedule information from the user schedule information storage means; wherein the means for establishing this association includes interest estimation means for estimating, from the contents of the user schedule information, which advertisements the user will be interested in; and this interest estimation means includes means for consulting a database in which has been stored information relating to what sort of advertising service a particular schedule item corresponds with, and for extracting a keyword serving to extract advertisement data that corresponds with the stored user schedule information; and there is provided advertisement presentation means which uses the keyword extracted by the interest estimation means to associate advertisement data that matches the keyword with the aforementioned user schedule information, and which presents the advertisement data in question along with the user schedule information.

The aforementioned advertisement data storage means can also store geographical region data serving as a condition for presenting an advertisement, and a user whereabouts estimation means can be provided for estimating, from the user's schedule information in the user schedule information storage means, which geographical region the user is currently in. The aforementioned advertisement presentation means can include means for associating advertisement data that corresponds with this estimated user whereabouts with a user's schedule information, and for presenting this advertisement data along with the schedule information.

The invention can include means for storing as user schedule information in the user schedule storage means, as a result of user input, advertisement data that has been presented along with user schedule information; and the interest estimation means can include means for estimating, from this advertisement data stored as schedule information, which advertisements the user will find interesting.

According to another aspect, this invention is user operable terminal equipment that is connected via a network to a server equipped with user schedule information storage means in which user schedule information can be stored, and with advertisement data storage means in which advertisement data has been stored; this terminal equipment comprising schedule information input means for inputting user schedule information to the user schedule information storage means; and display means whereby, as a result of user control, the schedule information storage means is consulted, and the schedule information of the user in question is acquired and displayed; wherein the display means comprises means for displaying, along with the acquired user schedule information, advertisement data stored in the advertisement data storage means of the server, said displayed advertisement data being that for which advertisement information associated with the user schedule information has been distributed along with the schedule information; and the advertisement data to be distributed along with this schedule information is advertisement data indicated by an advertisement item estimated to be of interest to the user on the basis of the user schedule information that has been input.

By installing programs in an information processing unit, this unit can be made to function as the various component parts of the aforementioned advertisement presentation system, and as the aforementioned server or terminal equipment. The present invention can therefore be implemented as a storage medium for storing software that serves to implement the functions of the various component parts of the invention.

### BRIEF DESCRIPTION OF THE DRAWINGS

Specific embodiments of the present invention will now be described, by way of example only, with reference to the accompanying of drawings in which:

FIG. 1 is a block diagram showing the configuration of a first embodiment of the present invention;

FIG. 2 shows an example of the account database;

FIG. 3 is a flowchart showing the processing when an advertiser registers an advertisement;

FIG. 4 shows an example of an advertisement input screen;

FIG. 5 shows an example of the advertisement category database;

FIG. 6 shows an example of the advertisement database;

FIG. 7 is a flowchart showing the processing for registering user information;

FIG. 8 shows an example of a user profile;

FIG. 9 shows an example of the user information dialogue;

FIG. 10 is a flowchart showing the processing for displaying a user schedule;

FIG. 11 shows an example of the user schedule database in the first embodiment;

FIG. 12 shows an example of a schedule data set;

FIG. 13 shows an example of a calendar screen;

FIG. 14 shows an example of the event input screen;

FIG. 15 is a flowchart showing the operation of the current interest estimation means;

FIG. 16 shows an example of the user interest database;

FIG. 17 shows an example of a noted user's future schedule found as the result of a search;

FIG. 18 shows an example of lifestyle information relating events to keywords;

FIG. 19 shows an example of a record associating a user with interest keywords;

FIG. 20 is a flowchart showing the operation of the advertisement distribution means;

FIG. 21 shows an example of search results;

FIG. 22 is a flowchart showing the processing for checking whether or not to send a noted advertisement to a noted user;

FIG. 23 shows an example of the user advertisement database;

FIG. 24 is a flowchart showing the processing for displaying an advertisement that has been sent;

FIG. 25 is a flowchart showing the processing for scheduling an advertisement;

FIG. 26 is a block diagram showing the configuration of a second embodiment of the invention;

FIG. 27 shows an example of a screen presented by the schedule input/output means in the second embodiment;

FIG. 28 shows an example of the user schedule database in the second embodiment;

FIG. 29 shows an example of a user profile in the second embodiment;

FIG. 30 is a flowchart showing the operation of interest estimation by the current interest estimation means in the second embodiment;

FIG. 31 is a block diagram showing the configuration of a third embodiment of the invention;

FIG. 32 shows an example of the user schedule database in the third embodiment;

FIG. 33 shows an example of a screen presented by the schedule input/output means in the third embodiment;

FIG. 34 is a flowchart showing the operation of interest estimation by the current interest estimation means in the third embodiment;

### DETAILED DESCRIPTION OF THE PREFERRED EMBODIMENTS

First Embodiment

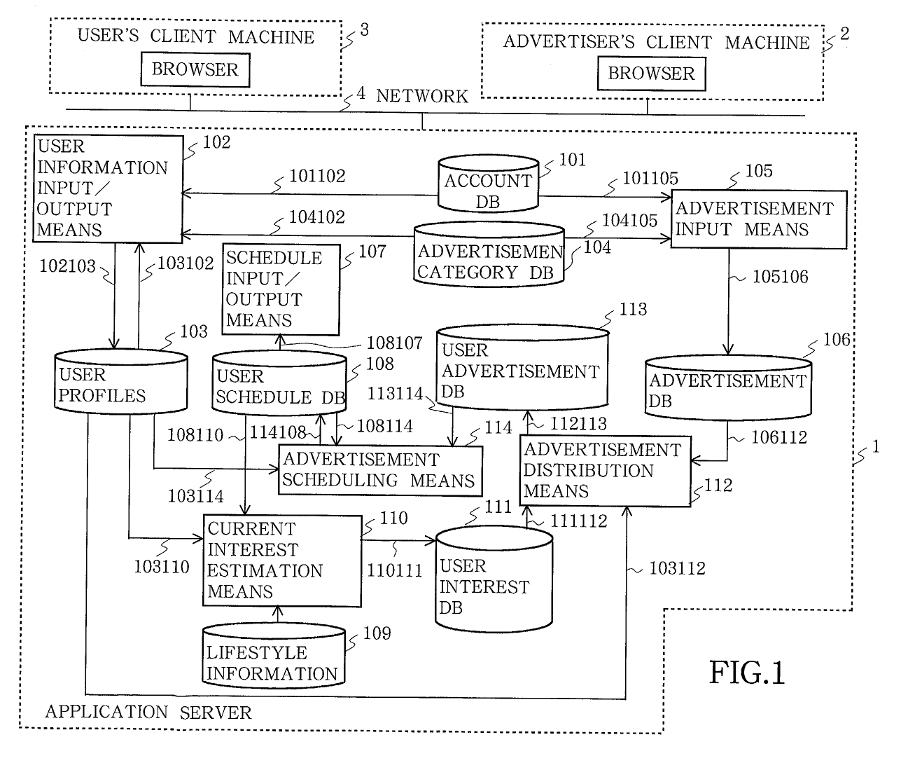

A first embodiment of this invention will be described with reference to FIG. 1.

An advertisement presentation system according to this first embodiment comprises: account database 101 for managing the login names and passwords that users and advertisers use to log into this system; user information input/output means 102 to which users can input the type of advertisement that they want to be sent to them and profile information such as their own name and address, and which can display the input personal information to the person who has input it; user profiles 103 that uses user information input/output means 102 to accumulate personal information that users have input; advertisement category database 104 in which various types of advertisement are listed, such as “shopping” and “sports events”; advertisement input means 105 whereby an advertiser can input, for each advertisement, advertisement-related information such as advertisement name, valid period, distribution conditions and related URLs; advertisement database 106 for accumulating advertisements that have been input from advertisement input means 105; schedule input/output means 107 whereby a user can input his personal schedule, and which serves to display advertisements in conjunction with input schedule information; user schedule database 108 for accumulating schedule data that has been input by schedule input/output means 107; lifestyle information 109 which is information associating related keywords with typical schedule items frequently input by schedulers; current interest estimation means 110 for using users' personal schedule information registered in user schedule database 108, and lifestyle information 109, to estimate the current interests of each user; user interest database 111 for storing users' interests calculated by current interest estimation means 110; advertisement distribution means 112 for distributing advertisement data stored in advertisement database 106 to users who, on the basis of user personal information stored in user profiles 103 and user interest information stored in user interest database 111, satisfy distribution conditions; user advertisement database 113 which is a buffer for temporarily storing advertisement data distributed by advertisement distribution means 112; and advertisement scheduling means 114 for calculating—from the state of each user's schedule in user schedule database 108 (i.e., how full the schedule is) and from a log of user clicks on advertisements, this log having been sent from schedule input/output means 107—which of the advertisement data stored in user advertisement database 113 it would be effective to display to the user, and when it would be effective to display these advertisement data. Advertisement scheduling means 114 also serves to copy the advertisement data to user schedule database 108.

First of all, descriptions will be given of the general hardware configuration and of the modes of use by advertisers and users when utilising this system.

In this system, the various means and databases for performing services for advertisers and users are run on application server 1. Application server 1 uses an information processing unit of the sort commonly used by Web servers and the like. The various means comprising this system can be implemented using CGI scripts that run on Web server programs on application server 1, or that cause a Web server program to run. Application server 1 is connected to network 4 and is set up so that it can be accessed from the information processing units of users and advertisers (hereinafter termed “client machines”). Network 4 is preferably implemented on the widely used Internet. Users and advertisers can receive, on their own client machines, services from the various means, by running various types of browser software on their own client machines and inputting to these browsers the URLs of the various means that run on application server 1.

In this first embodiment of the invention, a user who receives a schedule service will be termed simply a “user”, and a person who registers an advertisement and sends it to users will be termed an “advertiser”. A person who manages application server 1 will be termed the “service provider”.

Next, before describing the operation of this first embodiment, a description will be given of the operation whereby users and advertisers register accounts.

Advertisers and users register accounts on application server 1 in order to receive the services provided by this system. More specifically, a user and an advertiser register the following information:

1) Name: the user or advertiser name that will be input during login to this system.

2) Password: the user or advertiser password that will be input during login to this system. 3) Category: indicates whether the login person is a user or an advertiser.

Registration is preferably accomplished by the user or advertiser posting their details to the service provider, who then registers these details in the account database.

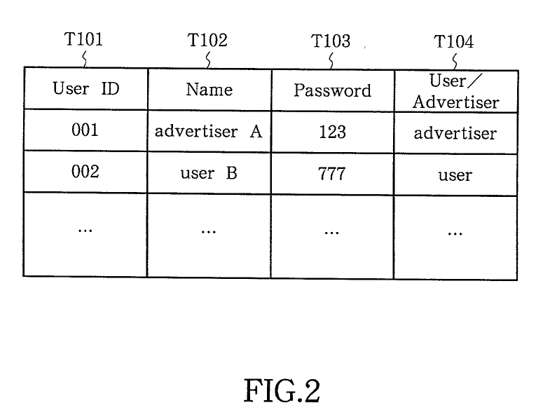

FIG. 2 shows an example of account database 101.

The first column (T10 1) is the field for user identification numbers that serve to identify users. The system assigns these identification numbers when details are registered. Any allocation method can be employed, provided that the same value does not appear more than once. However, for simplicity, it is preferable to assign numbers by counting up from 1 in the order of registration. Note that if this method is employed, the current maximum value of the identification number must for example be written to a file, and this value read and incremented by 1 every time an identification number is assigned.

The second column (T102) is the field for storing the names sent by users and advertisers.

The third column (T103) is the field for storing the passwords that have been sent from users and advertisers. In FIG. 2, the password has been entered as received. However, in order to further increase security, it is also feasible to register passwords after encrypting them, and then to decipher the encrypted version when the password has to be read.

The entries in the fourth column (T104) serve to distinguish whether the record in question pertains to a user or to an advertiser. If the record is that of a user, “user” is registered in this column, and if it is that of an advertiser, “advertiser” is registered.

In the example of FIG. 2, the first record illustrates the case where, in response to a registration request from an advertiser with the name “advertiser A” and the password “123”, the system has assigned “001” as the user identification number.

When an advertiser has registered an account, that advertiser is sent notification of a URL for accessing advertisement input means 105. When a user has registered an account, that user is sent notification of a URL for accessing user information input/output means 102, and a URL for accessing schedule input/output means 107. These notifications may be sent by post.

If a user name is already being used, the service provider must request the user or advertiser to use another name.

The service provider can require the advertiser or user to register other information in addition to the items described above. For example, the advertiser or user can be required to give an e-mail address to make it easier for the service provider to get in contact.

The operations of this system after the foregoing preparations have been made will now be explained one by one, under the following four-fold classification:

(1) An advertiser registers an advertisement.

(2) A user registers user information.

(3) A user manages his personal schedule.

(4) Sending an advertisement to a user's scheduler, on the basis of user preferences.

(1) The operation of an advertiser registering an advertisement

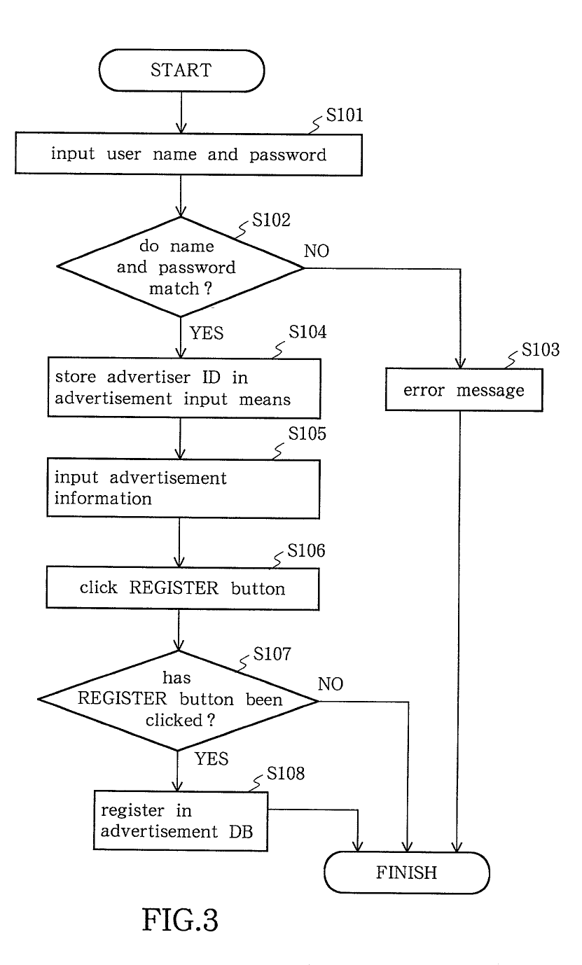

FIG. 3 is a flowchart showing the processing when an advertiser registers an advertisement.

Step S101

First of all, the advertiser accesses advertisement input means 105, having received notification of its URL when the account was registered. Advertisement input means 105 asks for the advertiser's name and password in order to confirm that the access is from a legitimate advertiser. In response to this request, the advertiser inputs his registered name and password. In the example of FIG. 2, advertiser A inputs “advertiser A” as his user name and “123” as his password.

Step S102

Advertisement input means 105 checks whether the name and password match by using the name as a key to search account database 101 (101105). If this check shows that the name and password match, the flow advances to S104. If they do not match, it advances to S 103.

Step S103

An error message is displayed and the processing is terminated. The wording of the error message can be, by way of example, “Name and password do not match. Processing will be terminated.”

Step S104

The value of the user identification number in the account database 101 record for which a matching name and password were confirmed in step S102, is stored in advertisement input means 105. For example, in the example of FIG. 2, if advertiser A has input the correct password, “001” is stored in advertisement input means 105 as the value of the user identification number. It will be assumed that this user identification number is stored in a memory of advertisement input means 105 until the flow depicted in FIG. 3 has finished. If a plurality of users try to use advertisement input means 105 simultaneously, a separate instance of advertisement input means 105 is started up on application server 1 for each such user. Consequently, the value of a stored user identification number is not re-written by another user. A mechanism for generating a separate instance for each user is a common feature of CGI programs.

Step S105

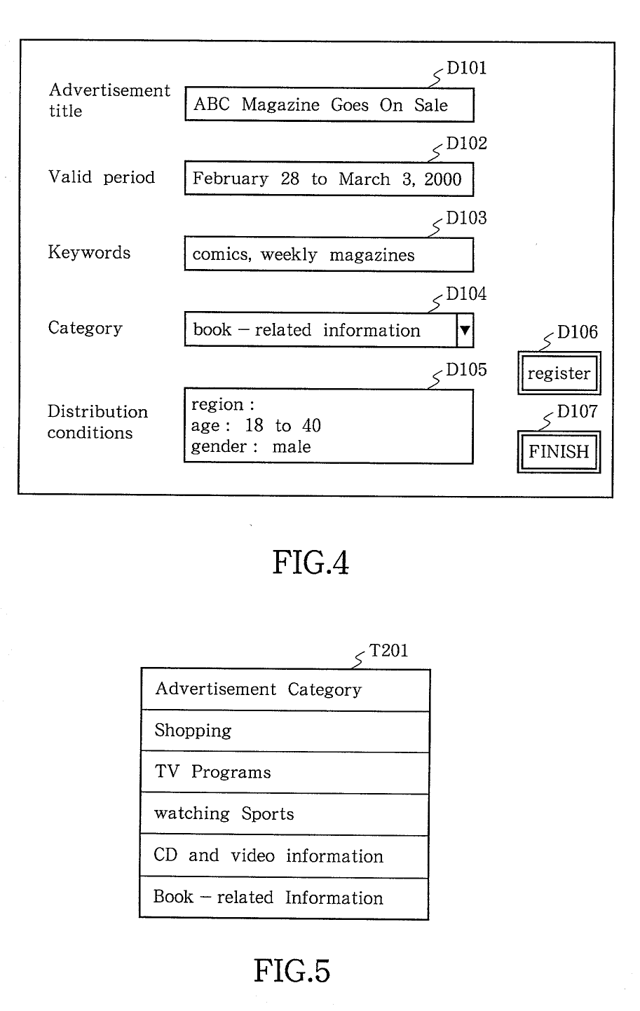

Advertisement input means 105 displays to the user a screen whereby the advertiser can input advertisement data. An example of an advertisement input screen is shown in FIG. 4.

Advertisement title (D101) is the field where the advertiser inputs a title for his advertisement. In the example of FIG. 4, an advertisement with the title “ABC Magazine Goes On Sale” is being input.

Valid period (D102) is the field where the advertiser inputs the period during which the advertisement will be distributed. In the example of FIG. 4, an advertisement that is valid over the period “February 28 to March 3, 2000” is being input. Because there are various formats for representing dates, it is acceptable to display an example of date format on the screen.

Keywords (D103) is the field where the advertiser uses keywords to indicate the content of the advertisement. Keywords can be entered with commas as separators. In the example of FIG. 4, the keywords “comics, weekly magazines” are being input.

Category (D104) is the field where the advertiser selects the type of advertisement. The service provider defines the types of advertisement in advance in advertisement category database 104. FIG. 5 shows an example of advertisement category database 104. In this case there is only one column (T201), and this contains keywords describing types of advertisement. In the example of FIG. 5, “shopping”, “TV programs”, “watching sports”, “CD and video information” and “book-related information” have been registered as the categories. When advertisement input means 105 generates an advertisement input screen, it reads the values in advertisement category database 104 (104105) and displays a user interface that enables the user to make a selection. This user interface can be implemented, for example, by a pull-down menu.

Distribution conditions (D105) is the field where the advertiser describes, as a set of conditions, the sort of user he wants to distribute the advertisement to. In this first embodiment, the advertiser inputs the following items:

Region: the advertiser specifies the geographical region in which target users will be living; “target users” signifying users to whom the advertisement will be distributed. Names of regions are input with commas as separators.

Age: the advertiser specifies the age group of target users. Minimum and maximum ages are input so that the advertisement will be distributed to users between these two ages.

Gender: the advertiser specifies the gender of target users, entering either “male” or “female”.

These conditions are all linked by AND. If no details are entered for a condition, this is taken as signifying “all”. For example, if no geographical region is specified, this means that the advertisement will be distributed to users in all regions. Although this first embodiment is configured so that the abovementioned three conditions can be specified, it is not necessary to employ just these three conditions. For example, the set of conditions can be extended to include the user's occupation as a specifiable condition. Note, however, that if the conditions that can be handled are altered, it is necessary to make a corresponding change to the fields listed in user profiles 103. This change will be described below. Namely, in this first embodiment there is no field for storing occupation as an entry in user profiles 103, but if the advertiser wants to specify occupation as a condition, “occupation” can be added to the fields in user profiles 103, in which case it has to be made possible to input and output this item in user information input/output means 102.

It may also be noted that in this first embodiment the minimum number of items necessary to explain the advantages of this system have been presented. However, it is perfectly feasible to increase the number of items input for an advertisement, so that the system is more convenient to use. For example, the URL of an advertiser's homepage can be input as an additional item.

Step S106

To register the input items as an advertisement, the advertiser clicks REGISTER button D106. To terminate the processing without registering, he clicks FINISH button D107.

Step S107

If the advertiser clicks REGISTER button D106, the flow advances to S108. If the advertiser clicks FINISH button D107, the processing is terminated.

Step S108

The advertisement data that has been input by the advertiser is registered in advertisement database 106 by advertisement input means 105 (105106). If required, at this point the value of the data entered in each field of the advertisement input screen can be checked, and if improper values have been input, the processing returns to S105 for re-input of advertisement data. For example, the flow returns to S105 if an impossible value such as 2/31 has been entered as the valid period of an advertisement.

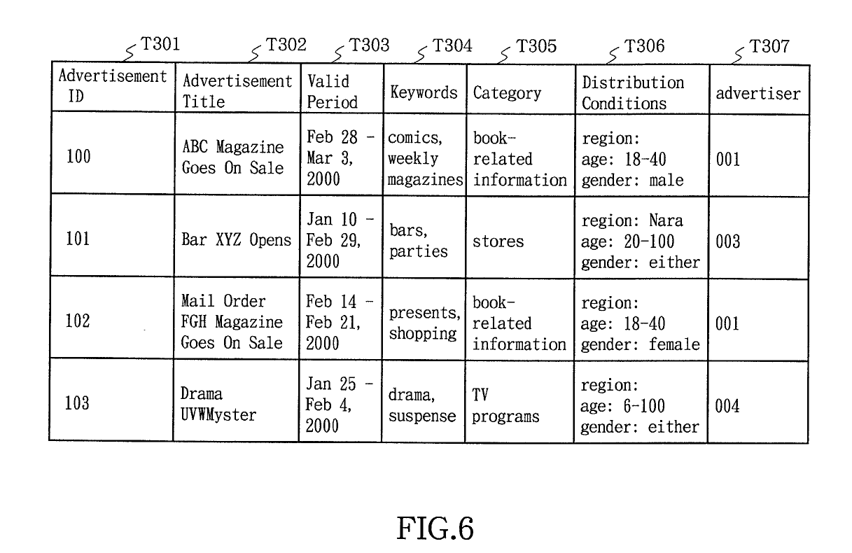

FIG. 6 shows an example of advertisement database 106.

The first column (T301) is the field for advertisement identification numbers that serve to identify advertisements. The system assigns these identification numbers when advertisement data are registered. Any allocation method can be employed, provided that the same value does not appear more than once. However, for simplicity, it is preferable to assign numbers by counting up from 1 in the order of registration. Note that if this method is employed, the current maximum value of the identification number must for example be written to a file, and this value read and incremented by 1 every time an identification number is assigned.

The second column (T302) is the field for storing the value that has been input for the advertisement title (D101). The third column (T303) is the field for storing the value that has been input for the valid period (D102). The fourth column (T304) is the field for storing the value that has been input for keywords (D103). The fifth column (T305) is the field for storing the value that has been input for category (D104). The sixth column (T306) is the field for storing the value that has been input for distribution conditions (D105). The seventh column (T307) is the field for storing the advertiser's identification number that was stored in step S104.

The result of having registered the advertisement in the example of FIG. 4 is the first record shown in FIG. 6.

When registration in the advertisement database is completed in this manner, the flow of registering the advertisement finishes.

(2) The operation of a user registering user information

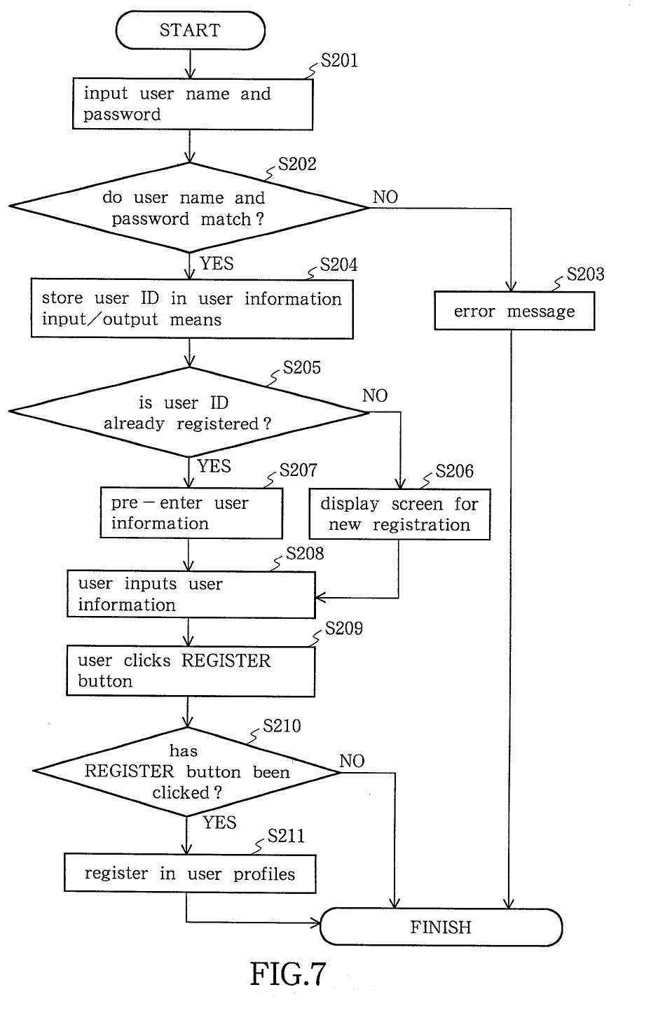

FIG. 7 is a flowchart showing the processing when a user registers user information.

Step S201

First of all, the user accesses user information input/output means 102, having received notification of its URL when the account was registered. User information input/output means 102 asks for the user's name and password first of all in order to confirm that the access is from a legitimate user. In response to this request, the user inputs his registered user name and password. In the example of FIG. 2, user B inputs “user B” as his user name and “777” as his password.

Step S202

User information input/output means 102 checks whether the name and password match, by using the name as a key to search account database 101 (101102). If this check shows that the name and password match, the flow advances to S204. If they do not match, it advances to S203.

Step S203

User information input/output means 102 displays an error message and terminates the processing. The wording of the error message can be, by way of example, “Name and password do not match. Processing will be terminated.”

Step S204

User information input/output means 102 stores the value of the user identification number in the account database 101 record for which a matching name and password were confirmed in step S202. For example, in the example of FIG. 2, if user B has input the correct password, “002” is stored in user information input/output means 102 as the value of the user identification number. It will be assumed that this user identification number is stored in a memory of user information input/output means 102 until the flow depicted in FIG. 7 has finished. If a plurality of users try to use user information input/output means 102 simultaneously, a separate instance of user information input/output means 102 is started up on application server 1 for each such user. Consequently, the value of a stored user identification number is not re-written by another user. A mechanism for generating a separate instance for each user is a common feature of CGI programs.

Step S205

In order to decide whether a user who is currently trying to access user information input/output means 102 is already a registered user or whether this is a first access, it is checked whether or not the user identification number that was stored in step S204 has already been entered in user profiles 103 (103102).

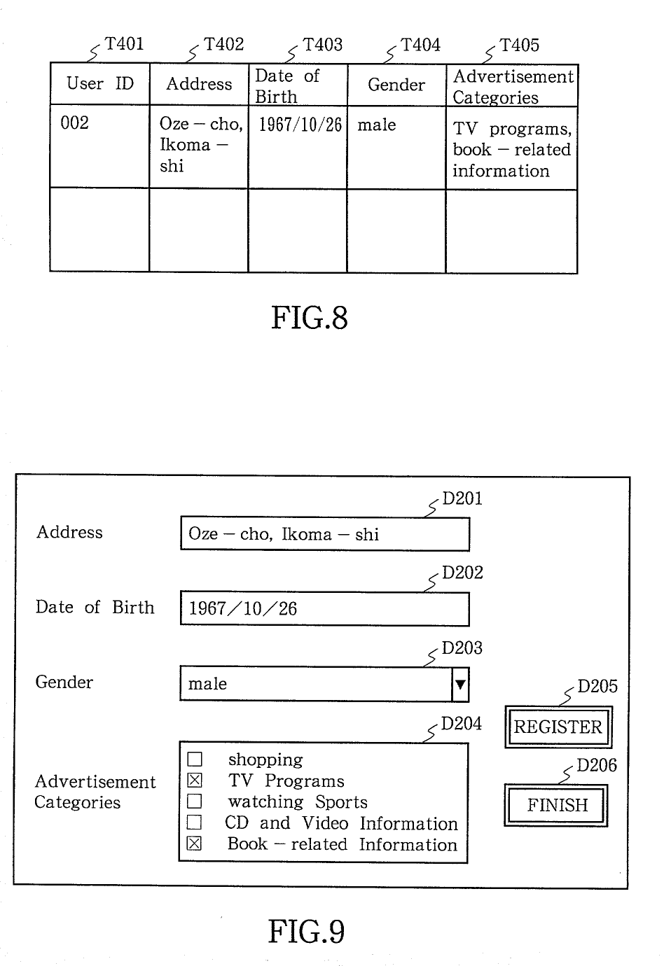

FIG. 8 shows an example of user profiles 103.

The first column (T40 1) is the field for user identification numbers that serve to identify users. These are the values (given in field T101 in account database 101) that the account database automatically assigns to users when they register for accounts.

The second column (T402) is the field for storing the user's address. The third column (T403) is the field for storing the user's date of birth. The fourth column (T404) is the field for storing the user's gender. The fifth column (T405) is the field for storing the category of advertisement that the user is interested in. Values stored here have been selected from the category names registered in advertisement category database 104. A plurality of advertisement categories can be selected, in which case they are stored with comma separators.

In the example of FIG. 8, the information given in the first record indicates that the profiled user has user identification number “002”, address “Oze-cho, Ikoma-shi”, date of birth “Oct. 26, 1967”, and is male. It also indicates that the advertisement categories in which the user is interested are “TV programs” and “book-related information”.

User information input/output means 102 searches, in the first column (T40 1) of user profiles 103, for the value of the user identification number in the account database 101 record for which a matching name and password were confirmed in step S202. If this value is not found, it decided that this is a first access, and the flow advances to step S206. If the value in question is found, it is decided that this user has already registered, and the flow advances to step S207.

Step S206

A dialogue for registering user information is displayed to the user (hereinafter, this will be termed the “user information dialogue”).

FIG. 9 shows an example of the user information dialogue. In this example:

1) Address (D201) is the field where the user enters his address.

2) Date of birth (D202) is the field where the user enters his date of birth. Because there are various formats for representing dates, it is acceptable to display an example of date format on the screen.

3) Gender (D203) is the field where the user enters his gender. To simplify the input process, this field can be designed so that the user can select from “male” and “female”.

4) Advertisement categories of interest (D204) is the field where the user selects the category or categories of advertisement that he is interested in. This field is displayed as follows: user information input/output means 102 reads all the categories that have been registered in advertisement category database 104 (104102) and displays them, adding a check box in front of each category name. The user inputs the categories that he is interested in by clicking check boxes.

Step S207

The user information dialogue is displayed for the user, with the user information being displayed in advance on the basis of the values entered in the record that was found in step S205. The correspondence between the fields in user profiles 103 and the display regions in the user information dialogue is as follows.

Address (T402) corresponds to Address (D201)

Date of birth (T403) corresponds to Date of birth (D202)

Gender (T404) corresponds to Gender (D203)

Category of advertisement of interest (T405) corresponds to Category of advertisement of interest (D204)

The display of category of advertisement of interest in D204 is obtained by user information input/output means 102 reading all the categories that have been registered in advertisement category database 104 (104102), adding a check box in front of each category, and putting a check mark in the check boxes of those categories that have been registered in the field for category of advertisement of interest in the record found in step S205.

In the example of FIG. 9, the user information of the first record in FIG. 8 has been read into the user information dialogue.

Although this embodiment of the invention has been explained in terms of registering the four items of user information described above, it is not necessary to employ just these four items. For example, a field can be added to enable the e-mail address of the user to be registered. Note, however, that the category of advertisement of interest is always a required field. Note also that because the distribution conditions that are input by the advertiser when he inputs advertisement data are specified using attribute values of the user information, if the user information fields are altered, the description of the distribution conditions will also have to be changed.

Step S208

The user inputs user information.

Step S209

To register the input entries as user information, the user clicks REGISTER button D205. To terminate the processing without registering, he clicks FINISH button D206.

Step S210

If the user clicks REGISTER button D205, the flow advances to S211. If the user clicks FINISH button D206, the processing is terminated.

Step S211

User information input/output means 102 registers, in user profiles 103, the user information that has been input by the user (102103). If required, at this point the value of the data entered in each field of the user information dialogue can be checked, and if improper values have been input, the processing returns to S208 for re-input of user information. The correspondence between the fields in user profiles 103 and the display regions in the user information dialogue is the same as described in relation to step S207.

The user identification number that was stored in step S204 is registered as the user identification number in user profiles field T401. This registration is performed in the manner described below. In the case of a new registration, a new record is added and then each value is registered.

If user information has already been registered, user profiles 103 is searched using the user identification number as a key, and the retrieved record is overwritten.

Note that in the case of registering the category of advertisement of interest, the categories that are checked in the user information dialogue are registered in field T405 of user profiles 103. If a plural number of categories have been checked, these categories are registered with comma separators.

When registration in user profiles 103 is completed, the flow shown in FIG. 7 is also finished.

(3) A user manages his personal schedule

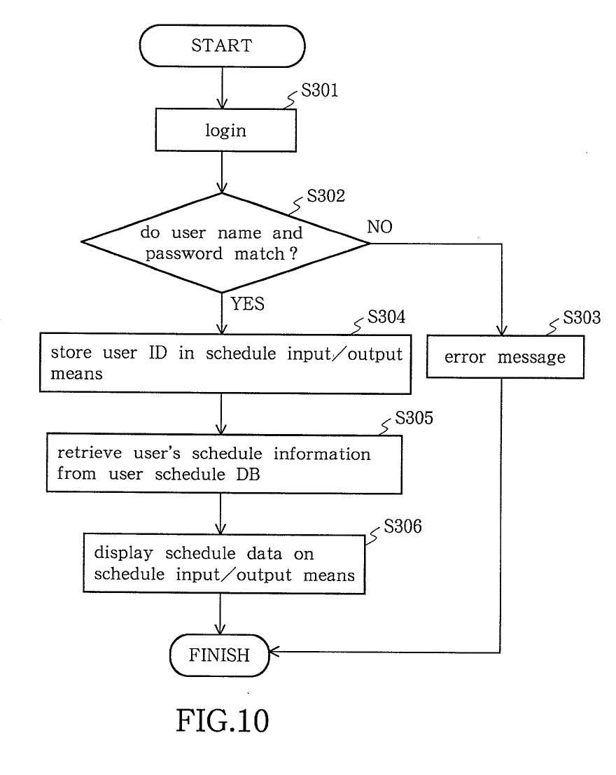

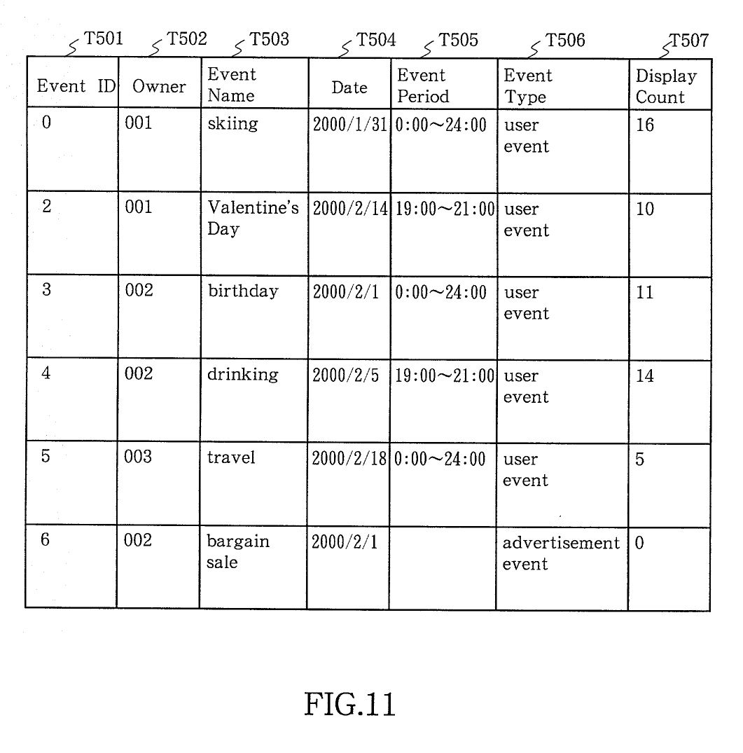

FIG. 10 is a flowchart showing the processing for displaying a user's personal schedule.

Step S301

First of all, the user accesses schedule input/output means 107, having received notification of its URL when his account was registered. Schedule input/output means 107 first of all asks for the user's name and password in order to confirm that the access is from a legitimate user. In response to this request, the user inputs his registered user name and password. In the example of FIG. 2, user B inputs “user B” as his name and “777” as his password.

Step S302

Schedule input/output means 107 checks whether the name and password match, by using the name as a key to search account database 101 (101107). If this check shows that the name and password match, the flow advances to S304. If they do not match, it advances to S303.

Step S303

Schedule input/output means 107 displays an error message and terminates the processing. The wording of the error message can be, by way of example, “Name and password do not match. Processing will be terminated.”

Step S304

Schedule input/output means 107 stores the value of the user identification number in the account database 101 record for which a matching name and password were confirmed in step S202. For instance, in the example of FIG. 2, if user B has input the correct password, “002” is stored in schedule input/output means 107 as the value of the user identification number.

It will be assumed that this user identification number is stored in a memory of schedule input/output means 107 until the flow depicted in FIG. 10 has finished. If a plurality of users try to use schedule input/output means 107 simultaneously, a separate instance of schedule input/output means 107 is started up on application server 1 for each such user. A mechanism for generating a separate instance for each user is a common feature of CGI programs.

Step S305

In order to display the personal schedule of the user who has logged in, the user's schedule information is retrieved from user schedule database 108.

FIG. 11 shows an example of user schedule database 108.

1) The first column (T501) is the field for event identification numbers that serve to identify events that have been registered in user schedule database 108 (hereinafter, such events will be termed simply “events”). The system assigns these identification numbers when events are registered. Any allocation method can be employed, provided that the same value does not appear more than once. However, for simplicity, it is preferable to assign numbers by counting up from 1 in the order of registration. Note that if this method is employed, the current maximum value of the identification number must for example be written to a file, and this value read and incremented by 1 every time an identification number is assigned.

2) The second column (T502) is the field for showing whose event it is, and this field serves to store the user identification number that has been assigned to each user.

3) The third column (T503) is the field for event names.

4) The fourth column (T504) is the field for the date on which the event will take place. The entries here are in the format “year/month/day”. Note, however, that this format is exemplary only. It may also be noted that although many conventional systems are capable of managing events that occur repeatedly and events that span several days, in this first embodiment, in order to simplify the description, it is assumed that the events in question take place on one specific day.

5) The fifth column (T505) is the field for showing the time period during which the event takes place. The entry here is in the format “start time finish time”. Note, however, that this format is exemplary only.

6) The sixth column (T506) is the field for the event type. Events are of the following two types.

“User events”: these are personal events that a user has registered using schedule input/output means 107.

“Advertisement events”: these are advertisements that an advertiser has registered and that the system has distributed to users after taking into consideration advertisement distribution conditions and user preferences. Advertisement events are registered with users as events. For example, in the case of an advertisement for a certain magazine, the date on which that magazine will go on sale is treated as an event and sent to the user schedule database. The specific way in which this is done will be described below (see “(4) Sending an advertisement to a user's scheduler, on the basis of user preferences”).

7) The seventh column (T507) gives the number of times that information relating to that record has been displayed on schedule input/output means 107. The initial value of this field is zero.

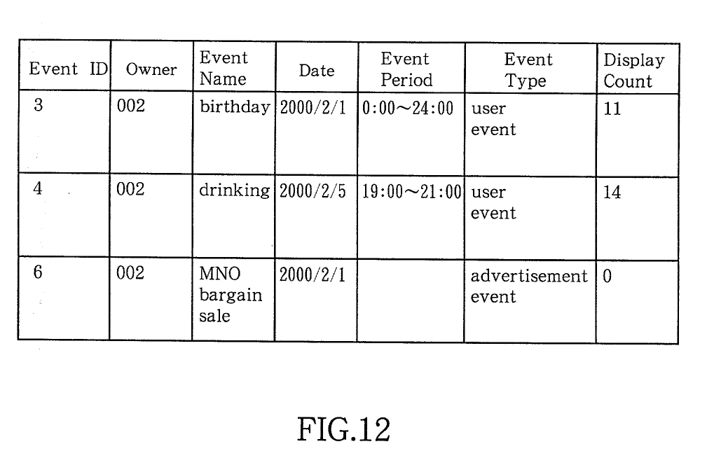

In order to display the personal schedule of a user who has logged in, schedule input/output means 107 searches the entries in the second column (T502) of user schedule database 108 for the user identification number that was stored in step S304, and retrieves those records having this user identification number (the result of this search will be termed the “schedule data set”). Schedule input/output means 107 then stores this schedule data set in a memory. FIG. 12 shows, as an example, the schedule data set obtained by retrieving, from the user schedule database example given in FIG. 11, schedule data having “002” as the user identification number.

Step S306

The schedule data set obtained in step S305 is displayed on a calendar screen.

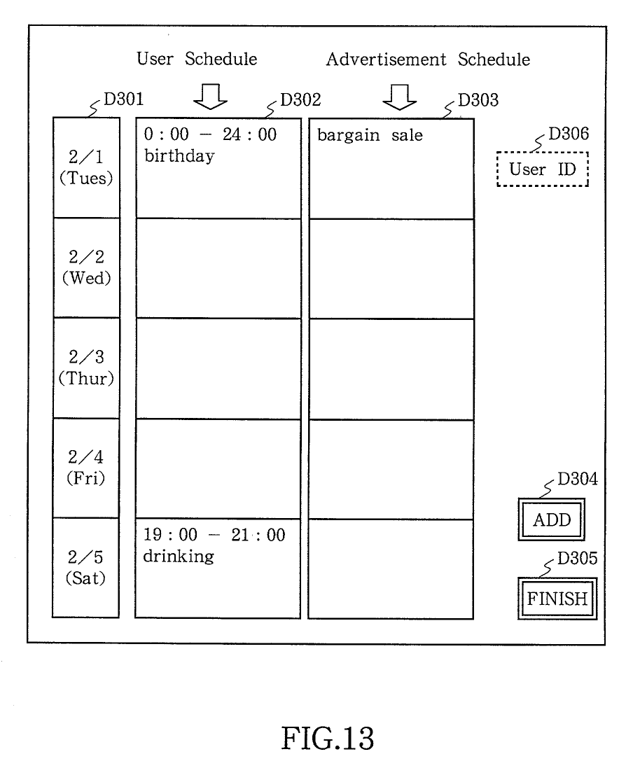

FIG. 13 shows an example of the calendar screen, in which:

1) The day display region (D301) is a region for showing when the event will take place.

2) The user event display region (D302) is the region that displays the personal schedule of the user.

3) The advertisement event display region (D303) is the region that displays advertisements to the user.

4) The ADD button (D304) is a button that the user clicks to add an event.

5) The FINISH button (D305) is a button for closing this screen.

6) The user identification number storage region (D306) serves to store, in the HTML file of the display screen, the user identification number that was stored by schedule input/output means 107 in step S304. It may be noted that because this number does not have to be displayed to the user, the HIDDEN attribute of HTML can be specified so that although this identification number is given in the HTML file for the screen, it is not displayed to the user.

It may also be noted that this screen configuration is the minimum configuration needed in order to explain the features of the present system. Various other functions can therefore be added when implementing a practical system, such as functions for moving or canceling events, and for changing the display period or displaying a month at a time.

As a more practical implementation, advertisement input means 105 and advertisement database 106 can have an extra field for the URL of the advertiser's homepage, so that each advertisement displayed on the calendar screen will generate a screen by linking to this URL.

Schedule input/output means 107 displays the records comprising the schedule data set as follows:

1) At start-up, it displays a five day period, starting with the present day, in the day display region (D301).

2) The values in the date field (T504) are displayed in the day display region (D301). However, if a day is not within the range of the day display region (D301), it is not displayed.

3) If the value in the type field (T506) is “user event”, information relating to that user event is displayed in the user event display region (D302), while if the value in the type field is “advertisement event”, information relating to that advertisement event is displayed in the advertisement event display region (D303).

4) In the case of a user event, the value in the time field (T505) and the value in the event name field (T503) are displayed in the user event display region, while in the case of an advertisement event, the value in the event name field (T503) is displayed in the advertisement event display region.

5) When information relating to an event has been displayed, the value in the seventh column (T507) is increased by one.

FIG. 13 shows an example of a calendar screen displaying the information contained in FIG. 12, covering the period from Feb. 1 to Feb. 5, 2000.

It may be noted that a conventional information processing unit has a current date and time management function, and that these data can be looked up from a program. In this first embodiment as well, each means can look up the current date and time from application server 1.

The operations that take place when an event is input will now be described.

First of all, when the user clicks the ADD button (D304), a screen for event input opens.

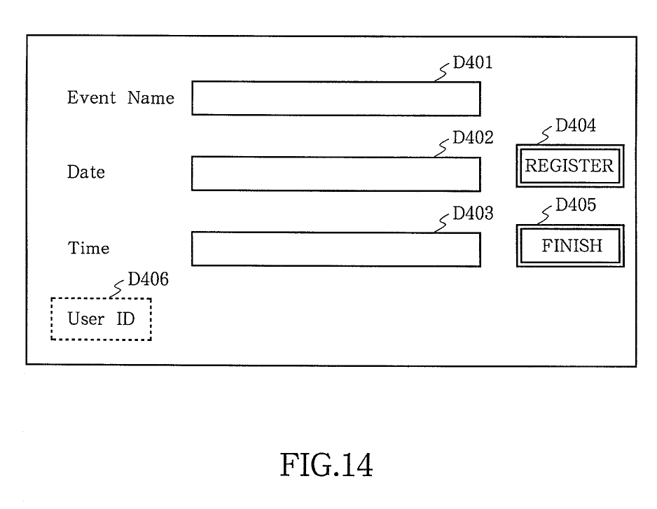

FIG. 14 shows an example of the event input screen.

1) Event name (D401) is a region for entering the name of an event.

2) Date (D402) is a region for entering the date on which the event will take place.

3) Time (D403) is a region for entering the time at which the event will take place.

4) The REGISTER button (D404) is a button which the user clicks to register an event.

5) The FINISH button (D405) is a button for closing this screen.

6) When the ADD button (D304) on the calendar screen is clicked and the event input screen opens, the value of the user identification number (D306) that is stored in the calendar screen is copied to give the user identification number (D406) in the event input screen. It may be noted that because this number does not have to be displayed to the user, the HIDDEN attribute of HTML can be specified so that although this identification number is given in the HTML file for the screen, it is not displayed to the user.

When the user clicks the REGISTER button, schedule input/output means 107 registers the data with user schedule database 108. Registration is performed as follows:

1) First of all, the user schedule database creates a new record.

2) An event identification number is assigned and stored in the event identification number field (T501).

3) The value of the user identification number in the event input screen (D406) is stored in the owner field (T502).

4) The value of the event name in the event input screen (D401) is stored in the event name field (T503).

5) The value of the date in the event input screen (D402) is stored in the date field (T504).

6) The value of the time in the event input screen (D403) is stored in the time field (T505).

7) “User event” is stored in the event type field (T506).

8) “0” is stored in the display number field (T507).

(4) Operation of sending an advertisement to the user's scheduler, on the basis of user preferences.

The description of this operation will be divided into the following three phases:

(4-1) The phase of estimating a user's interests

(4-2) The phase of sending advertisements to users

(4-3) The phase of displaying an advertisement that has been sent

(4-1) The phase of estimating a user's interests

In this phase, users' current interest information is extracted from the events registered for each user in the user schedule database. As has already been described, the system of the invention enables users themselves to set, by means of user information input/output means 102, the categories in which they are interested. However, expressing user interests in detail is difficult and only a rough indication of these interests can be given. Moreover, because users do not in fact change their interest information frequently, short term interests cannot be dealt with. This means that the setting of interest categories by user information input/output means 102 achieves a rough setting of fields in which users have a constant interest. As opposed to this, this present phase of estimating a user's interests calculates more detailed user interests, and is not restricted to constant interests, but instead calculates dynamically changing interests—i.e., users' current interests.

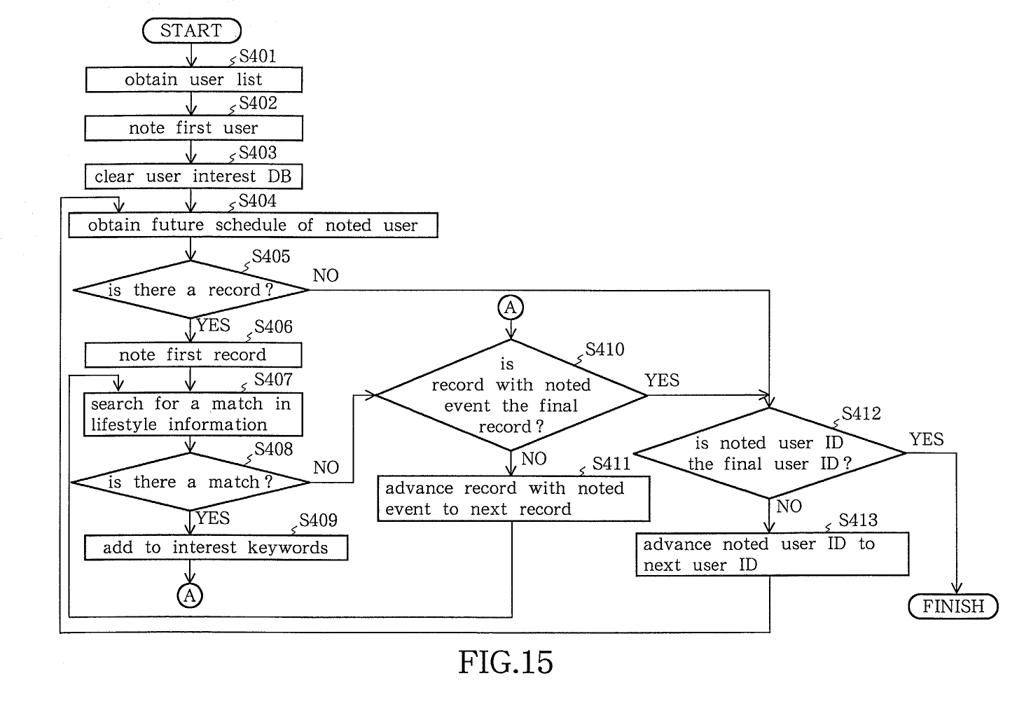

The processing for this phase is performed by current interest estimation means 110. FIG. 15 is a flowchart showing the operation of current interest estimation means 110.

Current interest estimation means 110 is started at an appropriate time (for example, every night at midnight).

Step S401

Current interest estimation means 110 requests user profiles 103 to send the user identification numbers of all users. In response to this request, user profiles 103 collects the first column (T401) values of all records and returns them to current interest estimation means 110 in the form of a character string in which the user identification numbers are connected by commas (103110). The order in which the user identification numbers are sent is not important, and it is acceptable to send them in the order in which they were registered in user profiles 103. Hereinafter, this character string will be called the “user identification number list”.

Step S402

Current interest estimation means 110 takes note of the first user in the user identification number list. Hereinafter, the user identification number that current interest estimation means 110 takes note of from the user identification number list will be termed the “noted user identification number”. Under normal circumstances it is most unlikely that there will be no users, and hence the user identification number list will not be empty. However, in order to construct a more robust system, it is feasible to arrange for this processing flow to be terminated if the user identification number list is empty.

Step S403

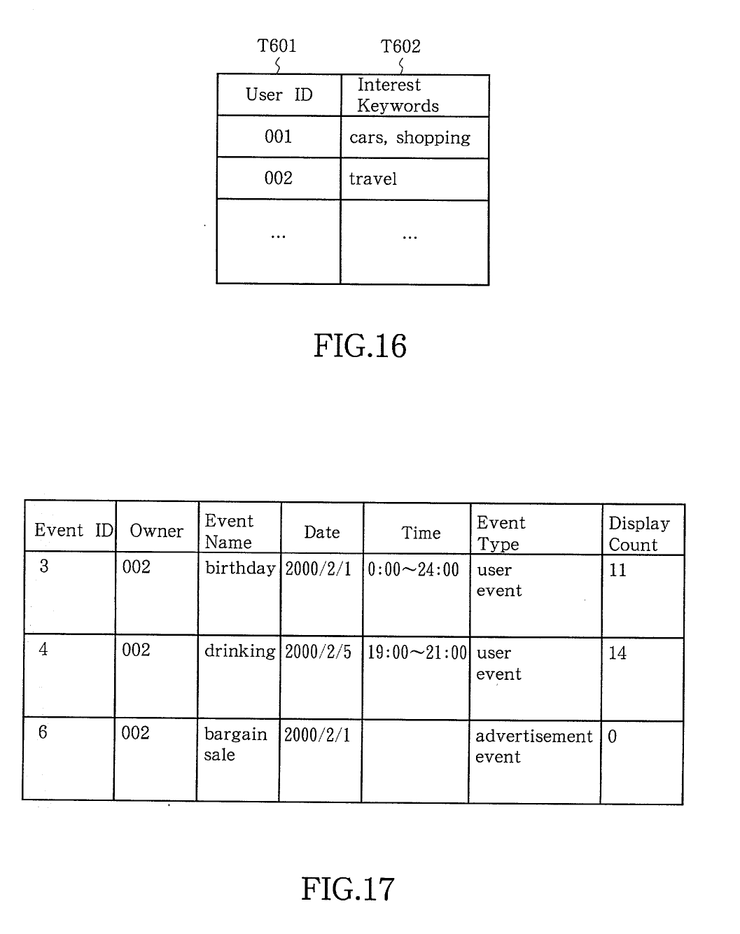

User interest database 111 is the database that stores the interests of each user, these having been estimated by current interest estimation means 110. FIG. 16 shows an example of user interest database 111.

1) The user identification number field (T601) serves to show whose interest information is being expressed, and stores user identification numbers.

2) The interest keyword field (T602) employs keywords to store the current interests of users whose user identification numbers appear in field T601. The format for entries in the keyword field (T602) is keywords connected by commas.

Current interest estimation means 110 clears user interest database 111, in which had been stored the results calculated when the current interest estimation means started the previous time.

Step S404

Current interest estimation means 110 retrieves from schedule database 108 records that meet the following condition.

Condition: the value of the owner field (T502) in the second column is the noted user identification number, and the value of the date field (T504) in the fourth column is the current date or a subsequent date.

If records meeting this condition are retrieved from the example user schedule database shown in FIG. 11, and if the noted user identification number is “002”, then the records shown in FIG. 17 are retrieved (108110). This table will be called the “noted user future schedule”.

Step S405

If there are no records in the noted user future schedule, the processing relating to this noted user finishes and the flow moves on to process the next user (i.e., the flow advances to S412). If there is a record in the noted user future schedule, the flow advances to S406.

Step S406

Current interest estimation means 110 takes note of the first record in the noted user future schedule. Hereinafter, the event name in the record that has been noted in this way will be called the “noted event”.

Step S407

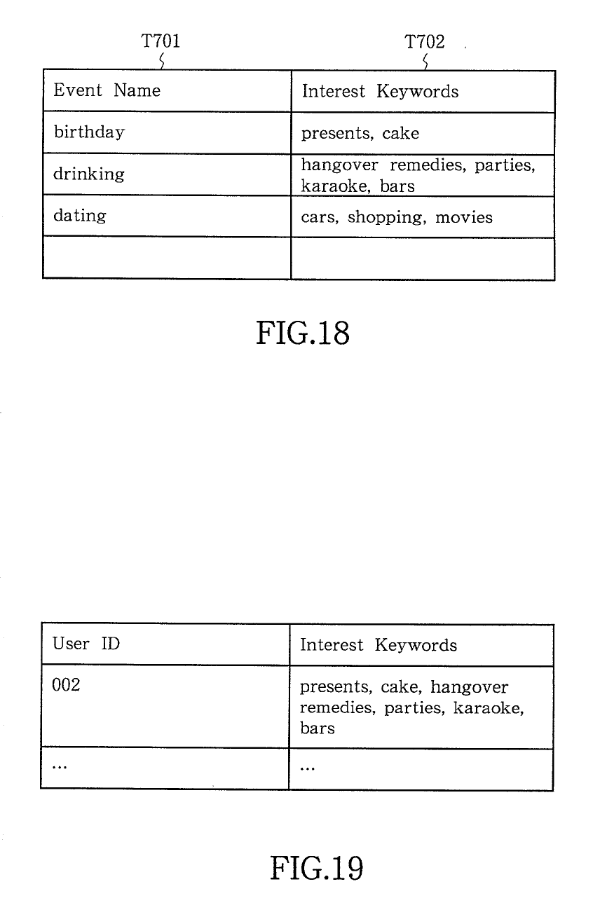

Current interest estimation means 110 uses lifestyle information 109 to extract, from the noted event, the current interest of the noted user. “Lifestyle information” is information that the service provider has registered in the system beforehand, and lifestyle information 109 is a table that relates keywords to typical events that users frequently register in user schedule database 108. FIG. 18 gives an example of this “lifestyle information”.

In FIG. 18, the event name field (T701) lists the names of events that are associated with user interests. The interest keyword field (T702) expresses, by a list of keywords, the interests of users whose schedule includes the event name entered in T701. Keywords are entered with comma separators. The example of FIG. 18 indicates that a user who has entered the event “birthday” in his schedule will have interests relating to “presents” and “cake”.

Current interest estimation means 110 uses the event name of the noted event as a key to search the event name field (T701) of lifestyle information 109. For example, when the second record in FIG. 17 is the noted event, lifestyle information 109 of FIG. 18 is searched using the event name “drinking” as a key, whereupon it is found that the second record in FIG. 18 matches.

Step S408

If current interest estimation means 110 finds a match in lifestyle information 109 in step S407, the flow advances to S409. If no match is found, it advances to S410.

Step S409 Current interest estimation means 110 registers, in user interest database 111, the value of the matched interest keyword field (T702) of lifestyle information 109. Registration is carried out as follows.

It is checked whether or not there is a record in user interest database 111 for which the value of the user identification number field (T601) is the noted user identification number. If there is such a record, this means that interests of the noted user have already been registered, in which case the value of the matched interest keywords field (T702) in lifestyle information 109 is added to the interest keywords of that record. If there is not such a record, this means that interests of the noted user have not yet been registered, in which case a new record is added, the noted user identification number is stored in the user identification number field (T601) of user interest database 111, and the value of the matched interest keywords field (T702) of lifestyle information 109 is added to the interest keywords field (T602) of user interest database 111. For example, when the result of the matching in the example given in the description of step S407 has been added to user interest database 111 of FIG. 16, then because there is already a record where the value of the user identification number field (T601) of user interest database 111 is the noted user's identification number “002”, the interest keywords matched to the event name “drinking”—namely, “hangover remedies”, “parties”, “karaoke” and “bars”—are added to the value of the interest keywords field (T602) of this record.

Step 410

If the record with the noted event is the final record in the noted user future schedule, this means that processing relating to the current noted user has been completed, in which case the flow advances to S412 in order to perform the processing required for the next user. If the record with the noted event is not the final record of the noted user future schedule, interest information relating to the current noted user has to be extracted from another event, and the flow advances to S411.

Step S411

The record with the noted event in the noted user future schedule is advanced to the next record. The flow now advances to step S407.

Step S412

If the noted user identification number is the final number in the user identification number list, this means that processing has been completed for all users, whereupon this flow is terminated. If the noted user identification number is not the final number in the user identification number list, this means that there is still a user remaining to be processed, whereupon the flow advances to S413.

Step S413

The noted user identification number in the user identification number list is advanced by one, whereupon the flow advances to step S404.

(4-2) The phase of sending advertisements to users

In this phase, advertisement distribution means 112 distributes advertisements registered in advertisement database 106 to suitable users. Here, “suitable users” signifies users who meet any of the following conditions:

Condition 1: the user matches the distribution conditions (age, gender, etc.) for advertisements that the advertiser has input using advertisement input means 105.

Condition 2: the advertisement category that the advertiser has input using advertisement input means 105 matches one of the user's interest categories (of advertisements that the user would like to have sent to him), these having been input by the user by means of user information input/output means 102.

Condition 3: the keywords that express the contents of an advertisement, these having been input by the advertiser using advertisement input means 105, match the current interests of the user, these having been calculated by current interest estimation means 110.

It may be noted that this phase begins immediately after phase (4-1), as a result of current interest estimation means 110 starting up advertisement distribution means 112.

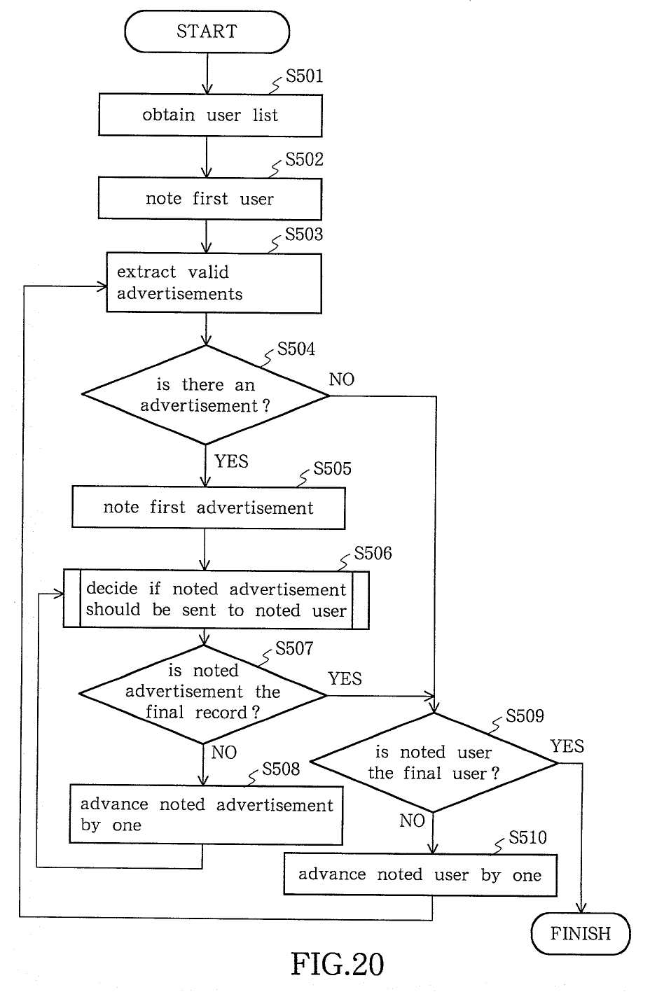

FIG. 20 is a flowchart of this phase, which is carried out by advertisement distribution means 112.

Step S501

Advertisement distribution means 112 requests user profiles 103 to send the user identification numbers of all users. In response to this request, user profiles 103 collects, for all records, the value of the first column (T401), in which the user identification number has been stored, connects these values with commas, and returns them to advertisement distribution means 112 (103112). The order in which the user identification numbers are sent is not important, and it is acceptable to send them in the order in which they were registered in user profiles 103. This list of user identification numbers has the same format as in step S401, and hereinafter will be called the “user identification number list”.

Step S502

Advertisement distribution means 112 takes note of the first user in the user identification number list. Hereinafter, the user identification number that advertisement distribution means 112 takes note of from the user identification number list will be termed the “noted user identification number”. Under normal circumstances it is most unlikely that there will be no users, and hence the user identification number list will not be empty. However, in order to construct a more robust system, it is feasible to arrange for this processing flow to be terminated if the user identification number list is empty.

Step S503

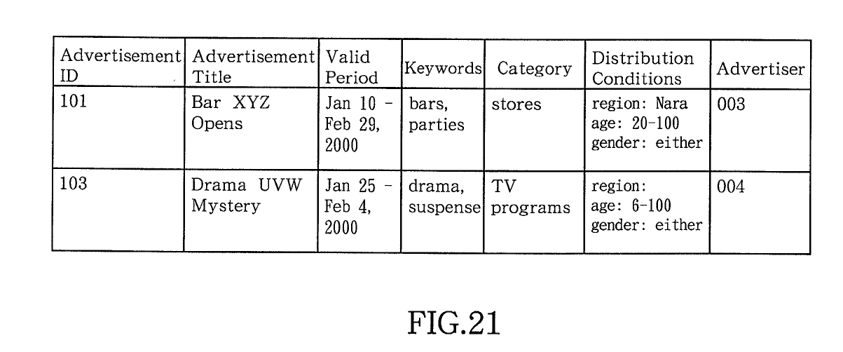

Advertisement distribution means 112 retrieves, from the advertisements that have been registered in advertisement database 106, advertisements with a valid period. That is to say, it retrieves those records such that the current date falls within the value of the advertisement valid period field (T303). In the example of FIG. 6, if the current date is Feb. 1, 2000, the records shown in FIG. 21 are retrieved. Hereinafter, the records retrieved in this way will be termed the “advertisement list”.

Step S504

If there are no records in the advertisement list, this means that there are no advertisements for advertisement distribution means 112 to distribute, and therefore the flow moves on to process the next user and advances to S509. If the advertisement list does contain one or more records, the flow advances to S505 in order to distribute the advertisement.

Step S505

Advertisement distribution means 112 takes note of the first record in the advertisement list. Hereinafter, the advertisement that advertisement distribution means 112 takes note of will be termed the “noted advertisement”.

Step S506

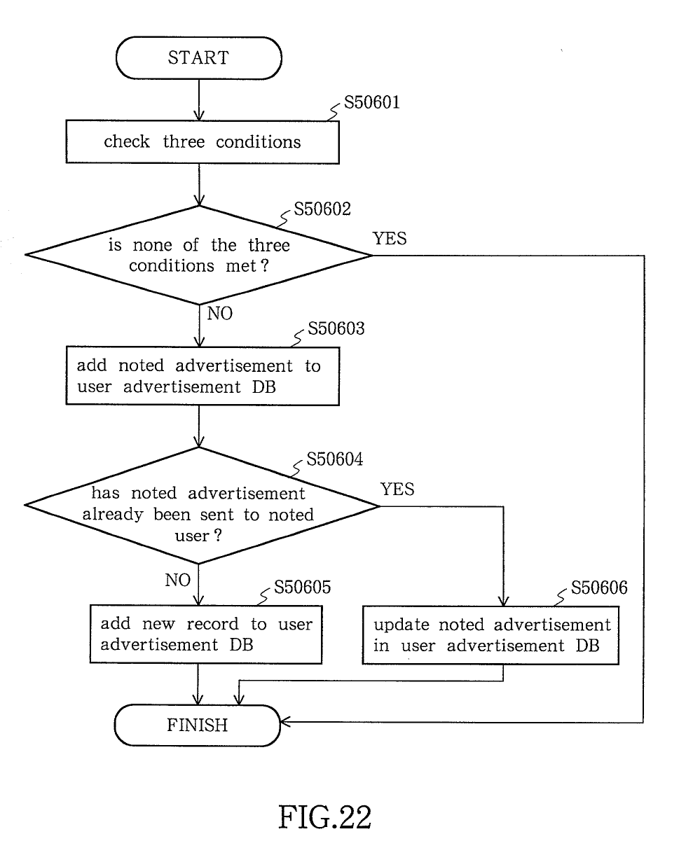

Advertisement distribution means 112 checks whether the noted advertisement should be sent to the user with the noted user identification number. If this checking process gives a positive result, the noted advertisement is sent. The details of this processing step are shown by the flow depicted in FIG. 22 (i.e., comprising step S50601 to step S50606).

Step S50601

Advertisement distribution means 112 checks the three previously described conditions (see “4-2: The phase of sending advertisements to users”).

Checking Condition 1:

Advertisement distribution means 112 requests user profiles 103 to send the user information associated with the noted user identification number. After receiving this request, user profiles 103 retrieves the user record where the value of the first column (T401) is the noted user identification number, and sends this record back to advertisement distribution means 112. It may be noted that this processing always retrieves a single record, since the user identification number list has already been obtained in step S501. Advertisement distribution means 112 checks whether or not the values for geographical region, age and gender in the distribution conditions (T306) of the noted advertisement respectively match the address (T402), date of birth (T403) and gender (T404) of the noted user. It is assumed that this will involve suitable processing for calculating the age of the noted user from the current date and the given date of birth. If all of these conditions are satisfied, advertisement distribution means 112 decides that Condition 1 is met, but if even one of the attribute values does not match, it decides that Condition 1 is not met.

Checking Condition 2:

Advertisement distribution means 112 checks whether not the category (T305) of the noted advertisement is included in the value of the interest category field (T405) of the noted user. If it is included, advertisement distribution means 112 decides that Condition 2 is met, while if it is not included, it decides that Condition 2 is not met.

Checking Condition 3:

Advertisement distribution means 112 requests user interest database 111 to send the interest information corresponding to the noted user identification number. After receiving this request, user interest database 111 retrieves the user record where the value of the first column (T601) is the noted user identification number, and sends this record back to advertisement distribution means 112. If no record is found at this point, advertisement distribution means 112 decides that Condition 3 is not met. If a record is found and if at least one keyword of the interest keywords (T602) of the retrieved record is included among the keywords (T304) of the noted advertisement, it decides that Condition 3 is met. Conversely, if none of the keywords is included among the keywords (T304) of the noted advertisement, it decides that Condition 3 is not met.

Step S50602

If none of the three conditions has been met, advertisement distribution means 112 decides that it is not necessary to send the noted advertisement to the noted user, and therefore terminates this flow. If at least one of the conditions has been met, the flow advances to step S50603 in order to send the noted advertisement.

Step S50603

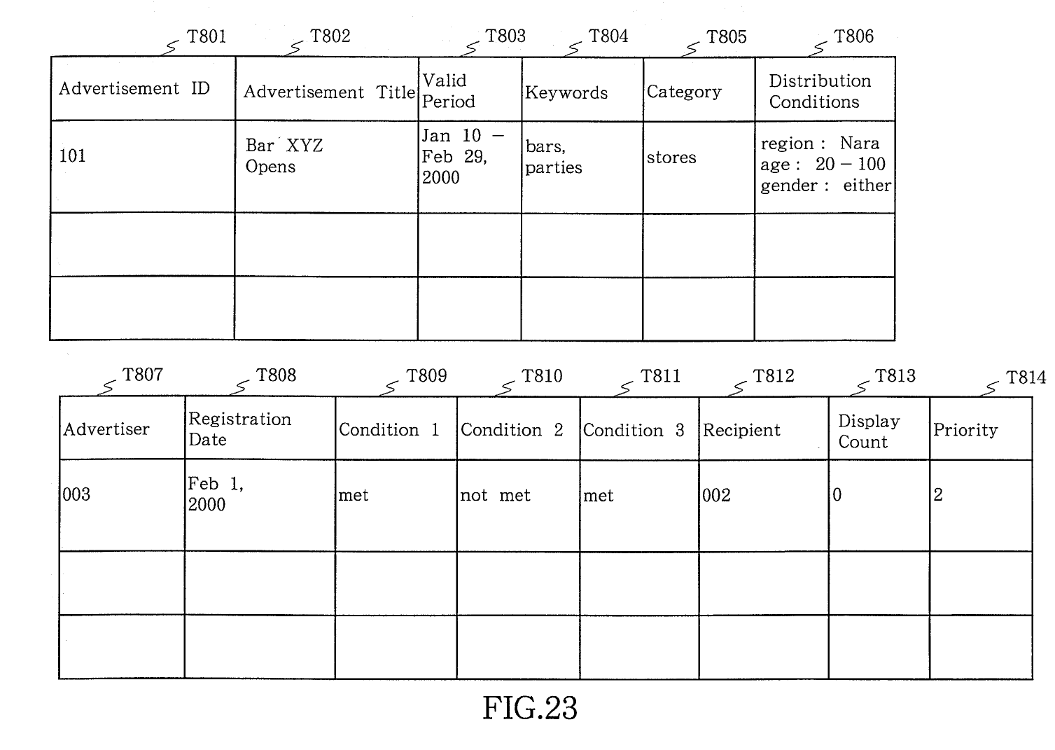

By means of this step and subsequent steps, advertisement distribution means 112 sends the noted advertisement to user advertisement database 113. First of all, user advertisement database 113 will be described with reference to FIG. 23.

The fields in user advertisement database 113 comprise those of advertisement database 106 plus several additional fields.

In user advertisement database 113 of this first embodiment, the first to the seventh columns (T801 to T807) are respectively the same as T301 to T307 in advertisement database 106.

The eighth column (T808) of user advertisement database 113 is a field for storing the date on which advertisement distribution means 112 registered the advertisement with user advertisement database 113. The ninth column (T809) is a field for storing the result of the check of Condition 1 in step S50601. The tenth column (T810) is a field for storing the result of the check of Condition 2 in step S50601. The eleventh column (T811) is a field for storing the result of the check of Condition 3 in step S50601. The twelfth column (T812) is a field for storing the user identification number of the user to whom the advertisement is to be sent. The thirteenth column (T813) is a field for storing the number of times that the advertisement has been displayed by schedule input/output means 107. The fourteenth column (T814) is a field for storing the priority attached to displaying the advertisement to the user. The way in which this is calculated will be described below.

Advertisement distribution means 112 checks, in user advertisement database 113, whether or not the noted advertisement has already been sent to the noted user. To do this, it retrieves, from user advertisement database 113, records with a first column (T80 1) value that is the advertisement identification number of the noted advertisement, and with a twelfth column (T812) value that is the noted user identification number. If it finds a record, this means that the advertisement has already been sent (such a record will be called a “noted advertisement sent record”). If no such record is found, this means that the advertisement has not yet been sent.

Step S50604

If the advertisement has not yet been sent, the flow advances to step S50605. If the record has already been sent, it advances to step S50606.

Step S50605

Advertisement distribution means 112 creates a new record for user advertisement database 113, storing the following values in the various fields.

Namely, it copies the T301 to T307 values of the noted advertisement into the first to the seventh columns respectively (T801 to T807) of the new record.

It stores the current date in the eighth column (T808). It stores the result of the check of Condition 1 in step S50601 in the ninth column (T809). If this check showed that Condition 1 is met, a “1” is written in this ninth column, while if Condition 1 is not met, a “0” is written. It stores the result of the check of Condition 2 in step S50601 in the tenth column (T810). If this check showed that Condition 2 is met, a “1” is written in this tenth column, while if Condition 2 is not met, a “0” is written. It stores the result of the check of Condition 3 in step S50601 in the eleventh column (T811). If this check showed that Condition 3 is met, a “1” is written in this eleventh column, while if Condition 3 is not met, a “0” is written. It stores the noted user identification number in the twelfth column (T812). It stores a “0” in the thirteenth column (T813). The fourteenth column (T814) is left blank.

When this processing finishes, advertisement distribution means 112 terminates the flow shown in FIG. 22 and continues the flow shown in FIG. 20.

Step 50606

Advertisement distribution means 112 re-writes the noted advertisement sent record in user advertisement database 113 as follows.

In the ninth column (T809) it stores the result of the check of Condition 1 in step S50601. If this check showed that Condition 1 is met, a “1” is written in this ninth column, while if Condition 1 is not met, a “0” is written. In the tenth column (T810) it stores the result of the check of Condition 2 in step S50601. If this check showed that Condition 2 is met, a “1” is written in this tenth column, while if Condition 2 is not met, a “0” is written. In the eleventh column (T811) it stores the result of the check of Condition 3 in step S50601. If this check showed that Condition 3 is met, a “1” is written in this eleventh column, while if Condition 3 is not met, a “0” is written. Fields other than these are not rewritten.

When this processing finishes, advertisement distribution means 112 terminates the flow shown in FIG. 22 and continues the flow shown in FIG. 20.

Step S507

If the noted advertisement is the final record, this means that processing of the current noted user has been completed, whereupon advertisement distribution means 112 performs step S509. If the noted advertisement is not the final record, this means that further processing of the current noted user remains, whereupon advertisement distribution means 112 performs step S508.

Step S508

Advertisement distribution means 112 advances the noted advertisement by one, and advances to step S506.

Step S509

If the noted user is the final user, advertisement distribution means 112 terminates this flow. If the noted user is not final user, advertisement distribution means 112 has to process another user and therefore performs step S510.

Step S510

Advertisement distribution means 112 advances the noted user by one, and advances to step S503.

(4-3) The phase of displaying an advertisement that has been sent

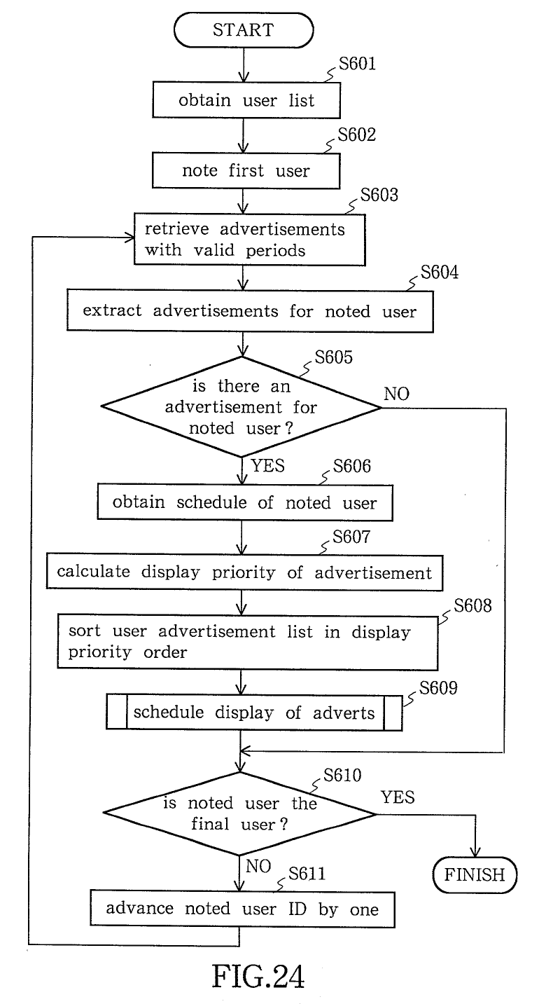

In this phase, advertisement scheduling means 114 schedules and sends, to user schedule database 108, advertisements that have been registered in user advertisement database 113. FIG. 24 shows a flowchart of this phase.

Step S601

Advertisement scheduling means 114 requests user profiles 103 to send the user identification numbers of all users. In response to this request, user profiles 103 collects, for all records, the value of the first column (T401), in which the user identification number has been stored, connects these with commas, and returns them to advertisement scheduling means 114 (103114). The order in which the user identification numbers are sent is not important, and it is acceptable to send them in the order in which they were registered in user profiles 103. This list of user identification numbers has the same format as in step S401, and hereinafter will be called the “user identification number list”.

Step S602

Advertisement scheduling means 114 takes note of the first user in the user identification number list. Hereinafter, the user identification number that advertisement scheduling means 114 takes note of from the user identification number list will be termed the “noted user identification number”. Under normal circumstances it is most unlikely that there will be no users, and hence the user identification number list will not be empty. However, in order to construct a more robust system, it is feasible to arrange for this processing flow to be terminated if the user identification number list is empty.

Step S603

Advertisement scheduling means 114 retrieves, from the advertisements that have been registered in user advertisement database 113, advertisements with a valid period. That is to say, it retrieves records such that the current date or a future date falls within the value of the advertisement valid period field (T803). It is possible that no such records will be retrieved.

Step S604

Advertisement scheduling means 114 retrieves, from the records retrieved in step S603, those records where the value of field T812, which indicates where the advertisement is to be sent, is the noted user identification number. The records that meet this criterion will be termed the “user advertisement list”. It is possible that no such records will be retrieved. Note that if no records are retrieved in step S603, no records will be retrieved in step S604 either.

Step S605

If the user advertisement list is empty, this means that processing relating to the current noted user has been completed, whereupon step S610 is performed. If the user advertisement list is not empty, step S606 is performed.

Step S606

Advertisement scheduling means 114 transfers the identification number of the noted user to user schedule database 108 and requests the schedule of the noted user. In response to this request, user schedule database 108 sends back records where the value of the second column (T502) is the noted user identification number. Hereinafter, the records sent back in this way will be termed the “noted user schedule”.

Step S607

Schedule input/output means 107 has limited display region space. For this and other reasons, advertisements that are better suited to the user are selected from the advertisements that have been registered in user advertisement database 113, and these selected advertisements are displayed. To implement this operation, advertisement scheduling means 114 calculates the display priority for each record in the user advertisement list. Display priority is calculated as follows.

[Display priority]=[value of ninth column (T809)]+[value of tenth column (T810)]+[value of eleventh column (T811)]−[value of thirteenth column (T813)]

This formula has been designed so that the more fully an advertisement satisfies the three conditions listed in “(4-2) The phase of sending advertisements to users” (these three conditions being checked in step S50601), the more suited to the noted user that advertisement is judged to be, and the more preferentially it is displayed to the user. The formula is also designed so that, in order to ensure that more types of advertisement are displayed to the user, the less frequently an advertisement is displayed to a user, the greater the priority that is given to its display. Note, however, that this formula is only one example, and that it is also acceptable to calculate display priority by for example applying appropriate weightings to the various terms of the formula.

Step S608

Advertisement scheduling means 114 sorts the user advertisement list in display priority order.

Step S609

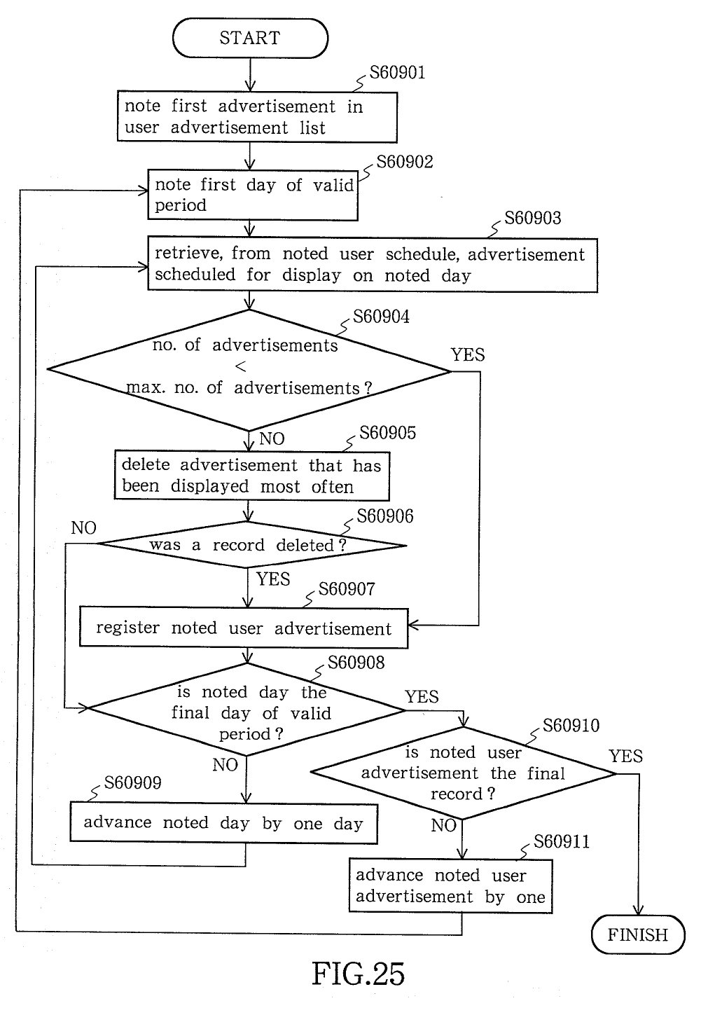

Advertisement scheduling means 114 schedules when each advertisement in the user advertisement list should be displayed to the user. FIG. 25 is a flowchart showing the advertisement scheduling processing that is performed by advertisement scheduling means 114.

Step S60901

Advertisement scheduling means 114 takes note of the first record in the user advertisement list. Hereinafter, a record in the user advertisement list that advertisement scheduling means 114 takes note of will be termed the “noted user advertisement”.

Step S60902

Advertisement scheduling means 114 takes note of the first day of the valid period given in the third column (T803) of the noted user advertisement. However, if the first day of the valid period is already in the past, advertisement scheduling means 114 takes note of today's date. Hereinafter, this day will be termed the “noted day”.

Step S60903

Advertisement scheduling means 114 retrieves, from the noted user schedule, advertisements scheduled to be displayed on the noted day. This is achieved by retrieving records where the value of the fourth column (T504) is the noted day, and the value of the sixth column (T506) is “advertisement event”.

Step S60904

If the number of records retrieved in step S60903 is less than or equal to the maximum number of advertisements, the flow advances to step S60907. If the number of records retrieved is greater than the maximum number of advertisements, the flow advances to step S60905. Here, “maximum number of advertisements” is the maximum number of advertisements that can be displayed in one day, and is a predetermined fixed value.

Step S60905

The record for which the value of the seventh column (T507) is greater than “0” and greater by the largest margin is retrieved and deleted from the records retrieved in step S60903. If no such records are found, no deletion is performed. If a plurality of records are found, one record is selected by a suitable method (e.g., the first record among those retrieved) and deleted. This processing means that, of the advertisements that have been displayed, the advertisement that has been displayed the most is deleted.

Step S60906

If a record was deleted in step S60905, the flow advances to step S60907 in order to add an advertisement. If a record was not deleted, the flow advances to step S60908.

Step S60907

Advertisement scheduling means 114 registers the noted user advertisement in user schedule database 108 in the following way.

1) A new record is added to user schedule database 108.

2) An event identification number is assigned to the first column (T501) of this record. The assignment method is the same as was used for registration of user events.

3) The noted user identification number is stored in the second column (T502) of the record.

4) The value of the advertisement title field (T802) of the noted user advertisement is stored in the third column (T503) of the record.

5) The noted day is stored in the fourth column (T504) of the record.

6) Nothing is stored in the fifth column (T505) of the record.

7) “Advertisement event” is stored in the sixth column (T506) of the record.

8) “0” is stored in the seventh column (T507) of the record.

Step S60908

If the noted day is the final day of the valid period of the noted user advertisement, the flow advances to step S60910 so that advertisement scheduling means 114 can process the next advertisement. If the noted day is not the final day of the valid period of the noted user advertisement, the flow advances to step S60909.

Step S60909

Advertisement scheduling means 114 advances the noted day by one day and proceeds to step S60903.

Step S60910

If the noted user advertisement is the final record in the user advertisement list, advertisement scheduling means 114 terminates this flow. If the noted user advertisement is not the final record in the user advertisement list, the flow advances to step S60911 in order to process the next advertisement.

Step S60911

Advertisement scheduling means 114 advances the noted user advertisement by one and proceeds to step S60902.

Step S610

If the noted user identification number is the final number in the user identification number list, this means that processing has been completed for all users, and advertisement scheduling means 114 terminates this flow. If the noted user identification number is not the final number in the user identification number list, advertisement scheduling means 114 advances to step S611 in order to process the next user.

Step S611

Advertisement scheduling means 114 advances the noted user identification number by one and proceeds to step S603.

Advertisements are displayed to users by means of the foregoing processing.

Second Embodiment

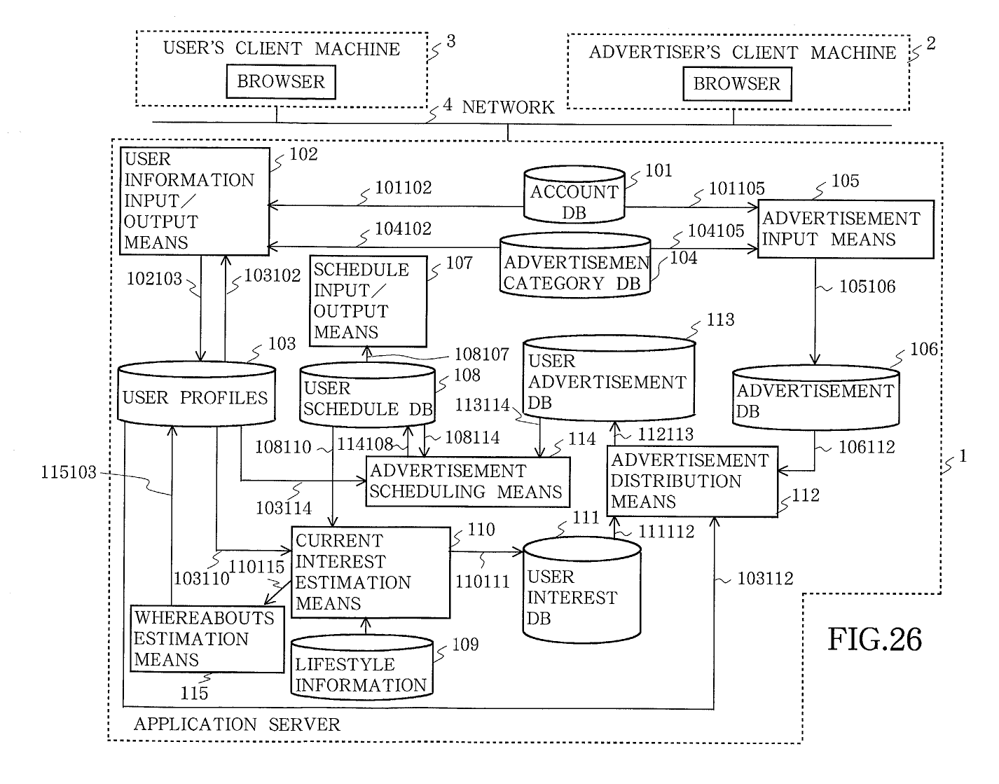

Next, a second embodiment of this invention will be described with reference to FIG. 26, which is a block diagram showing the configuration of this second embodiment.

A schedule and advertisement presentation system according to this second embodiment is obtained by adding, to the schedule and advertisement presentation system described in the first embodiment, a configuration for estimating the whereabouts of users and distributing advertisements that are in accord with these whereabouts.

Namely, this second embodiment is adapted so that when a user inputs an event using schedule input/output means 107, the place where this event will take place can also be input; and there is added to user schedule database 108 a field for storing the place where an event that has been input by schedule input/output means 107 will take place. Furthermore, there is provided whereabouts estimation means 115 for estimating, on the basis of the data in user schedule database 108, the whereabouts of users on each day. This second embodiment is adapted to be able to estimate the whereabouts of users by calling the aforementioned whereabouts estimation means 115 during the processing whereby current interest estimation means 110 estimates user interests. In order to store the whereabouts of users that have been estimated by this whereabouts estimation means 115, there is added to user profiles 103 a field for storing the whereabouts of users on each day. This second embodiment is also adapted to take user whereabouts into consideration when advertisement distribution means 112 distributes advertisements. As a result, whereas in the first embodiment only advertisements related to the current address of users could be sent, in this second embodiment advertisements that accord with the whereabouts of the user can be sent even if the user has temporarily changed his whereabouts, due to travelling or the like.

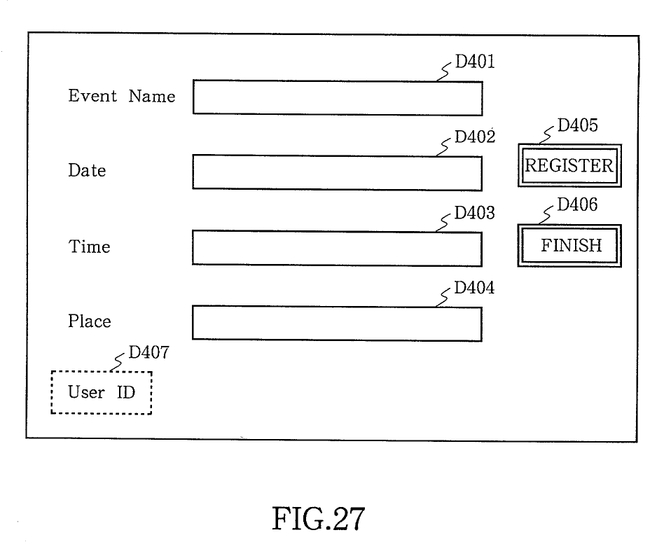

FIG. 27 gives an example of a schedule input/output means 107 display screen that has been adapted so that the place where an event will happen can also be input when a user inputs an event. In this second embodiment, region D404 is added for input of the place where the event will take place, and a geographical regional name is input in text form from the keyboard. Note, however, that the nature of this input can be altered in conformity with the actual application. For example, a more detailed place name can be input, or a map can be displayed and then clicked with a mouse pointer. A place does not have to be input for all events, and region D404 can be left blank.

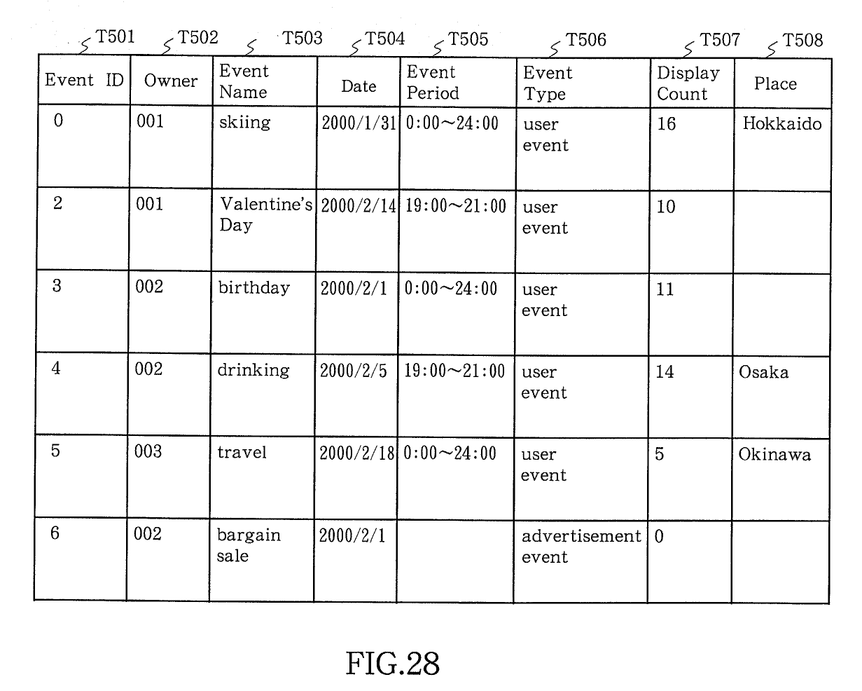

Next, FIG. 28 gives an example of user schedule database 108 to which has been added a field for storing the place at which an event will take place, the event in question having been input by schedule input/output means 107. The place field (T508) is the newly added field. The first record in FIG. 28 indicates that an event entitled “skiing” will take place in Hokkaido.

When the user clicks the REGISTER button, schedule input/output means 107 registers the event in user schedule database 108. The registration method comprises adding, to the procedure described in connection with the first embodiment, processing whereby the value of D404 in schedule input/output means 107 is stored in field T508 of user schedule database 108.

Next, a description will be given of the processing whereby user whereabouts is stored in user profiles 103.

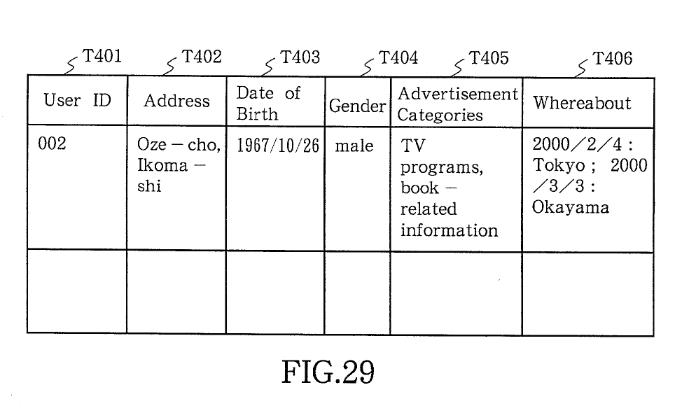

First of all, as shown in FIG. 29, a field T406 for storing the whereabouts of the user on each day is added to user profiles 103. This field indicates a place and a given date in the format “year/month/day:place”, and this combination describes the future whereabouts of the user in question. The example of FIG. 29 indicates that the user linked with the first record will be in Tokyo on Feb. 4, 2000 and in Okayama on Mar. 3, 2000.

This way of writing down the information is exemplary only. It would also be feasible for the time information to specify the exact hour. Moreover, if for example the user has moved to several locations in one day, two or more whereabouts can be entered for the same day. Because this simply means that advertisements relating to two or more places are sent to the users, it is not a problem.

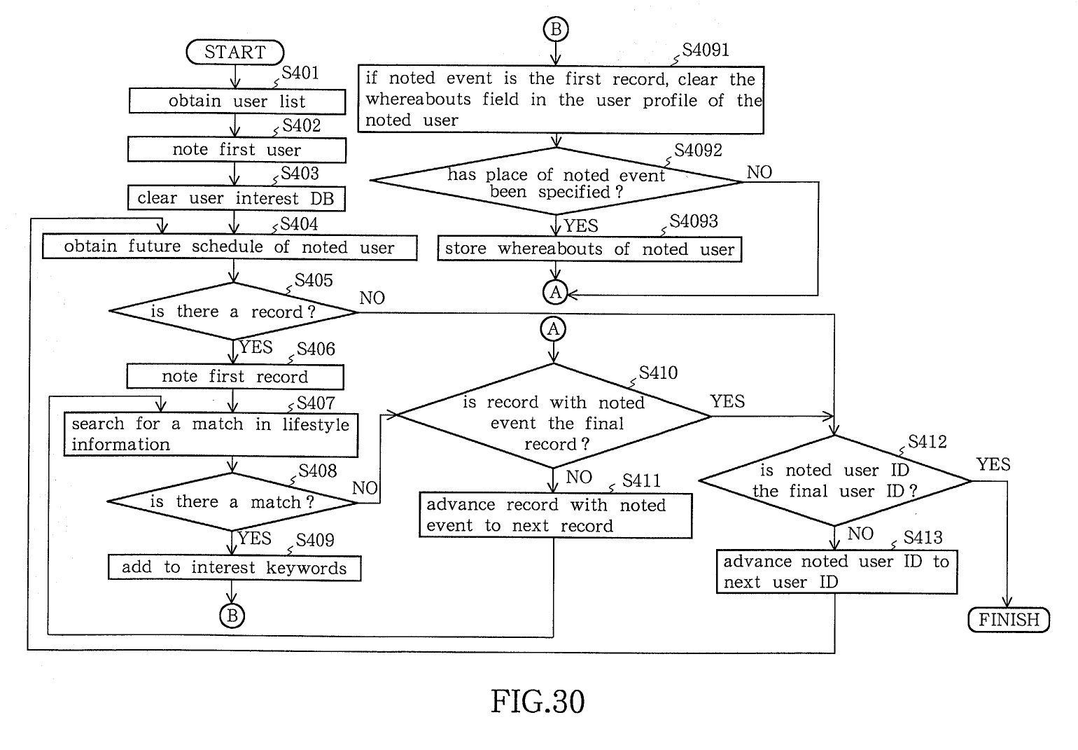

FIG. 30 gives a flowchart of processing adapted so that user whereabouts can also be estimated in the course of the processing whereby current interest estimation means 110 estimates user interests. This processing flowchart comprises, in addition to the flowchart given in FIG. 15 for the first embodiment, the following three steps inserted between steps S409 and S410 of the FIG. 15 flowchart, these three steps involving processing by whereabouts estimation means 115. First of all, current interest estimation means 110 performs step S4091.

Step S4091

If the noted record is the first record, the user identification number field of user profiles 103 is searched using as a key the user identification number of the noted user, and the value of the whereabouts field T406 of the retrieved record is cleared.

Next, current interest estimation means 110 sends to whereabouts estimation means 115 the user identification number of the noted user and the noted event (110115), and having received these, whereabouts estimation means 115 performs the following steps.

Step S4092

If place field T508 of the noted event has been specified, the flow advances to step S4093, but if the place field is empty, the flow advances to step S410.

Step S4093

The whereabouts of the noted user is stored in user profiles 103 in the following way (115103). For the noted event, the value of T504, which expresses the date on which the event will take place, and the value of T508, which expresses the place where it will take place, are converted to the format “year/month/day:place” and added to the value of the whereabouts field (T406) of the record in user profiles 103 for which the value of the user identification number (T401) is the noted user identification number.

By performing the foregoing processing for all future events and for each user, the future whereabouts of all users is stored in user profiles 103.

Note that in the foregoing description, whereabouts estimation means 115 simply uses, without modification, the place where the user's event will happen as the whereabouts of the user on that day, but that it is also feasible to estimate more precise whereabouts by using map data to estimate the route along which the user will move.

Finally, a description will be given of how user whereabouts is taken into consideration when distributing advertisements.

In the flow shown in FIG. 20, advertisement distribution means 112 distributed advertisements to users who met any of three conditions, but in this second embodiment, advertisement distribution means 112 distributes advertisements to users who additionally meet Condition 4 noted below.

Condition 4: the value of the geographical region in the advertisement distribution conditions that an advertiser has input using advertisement input means 105 matches the current whereabouts of the user.

Checking of Condition 4 will be described. Advertisement distribution means 112 requests user profiles 103 to send the user information associated with the noted user identification number. After receiving this request, user profiles 103 retrieves the user record where the value of the first column (T401) is the noted user identification number, and sends this record back to advertisement distribution means 112. It may be noted that this processing always retrieves a single record, since the user identification number list has already been obtained in step S501. If both of the following two checks are satisfied, advertisement distribution means 112 decides that Condition 4 is met. If either of the following checks is not satisfied, or if neither is satisfied, advertisement distribution means 112 decides that Condition 4 is not met.

Check 1: the value of the geographical region in the distribution conditions (T306) of the noted advertisement is included in the whereabouts field (T406) of the noted user.

Check 2: the date in the whereabouts field (T406) that matched in Check 1 is included in the valid period (T303) of the noted advertisement.

Thus, because user whereabouts can be estimated and advertisements suited to these whereabouts can be distributed, a user can receive advertisements that are in accord with his whereabouts. As a result, an advertisement provider can anticipate more effective advertising.

Third Embodiment

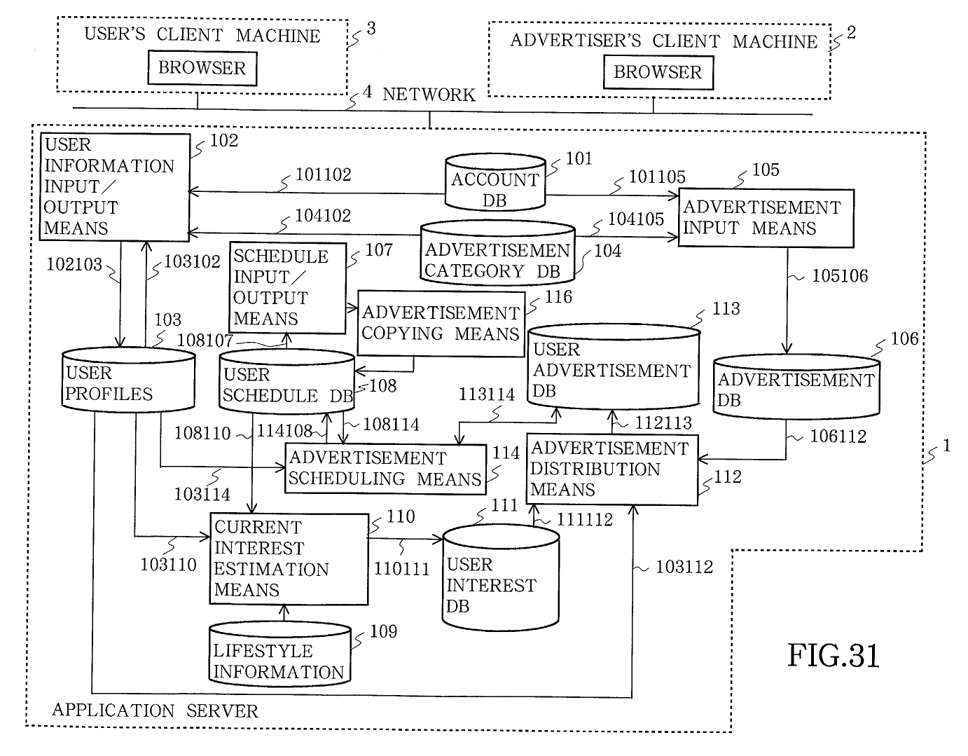

A schedule and advertisement presentation system according to a third embodiment of this invention will now be described. FIG. 31 is a block diagram of this third embodiment.

This third embodiment is obtained by adding, to the configuration described in the first embodiment, a configuration whereby a user can incorporate advertisements into his own schedule, so that advertisements that are similar to these incorporated event advertisements can thereafter be distributed to the user.

Namely, this third embodiment includes advertisement copying means 116 which allows an event advertisement displayed in D303 on the screen presented by schedule input/output means 107 (see FIG. 13) to be copied to the user schedule displayed in D302. Advertisement copying means 116 also ensures that the result of this copying operation is reflected in user schedule database 108. The effect of adding this advertisement copying means 116 is to enable a user to select an event advertisement whose deletion date he does not know, but which he doesn't wish to have deleted from the event advertisements, and to copy it to his own schedule, whereby he can refer to it whenever he wishes.

By adapting user schedule database 108 so that it can store event advertisement keywords as well, and by employing a log of user copying of event advertisements into the user's own schedule, current interest estimation means 110 can be adapted to estimate user interests so that advertisements similar to the event advertisements that the user has copied can thereafter be distributed.

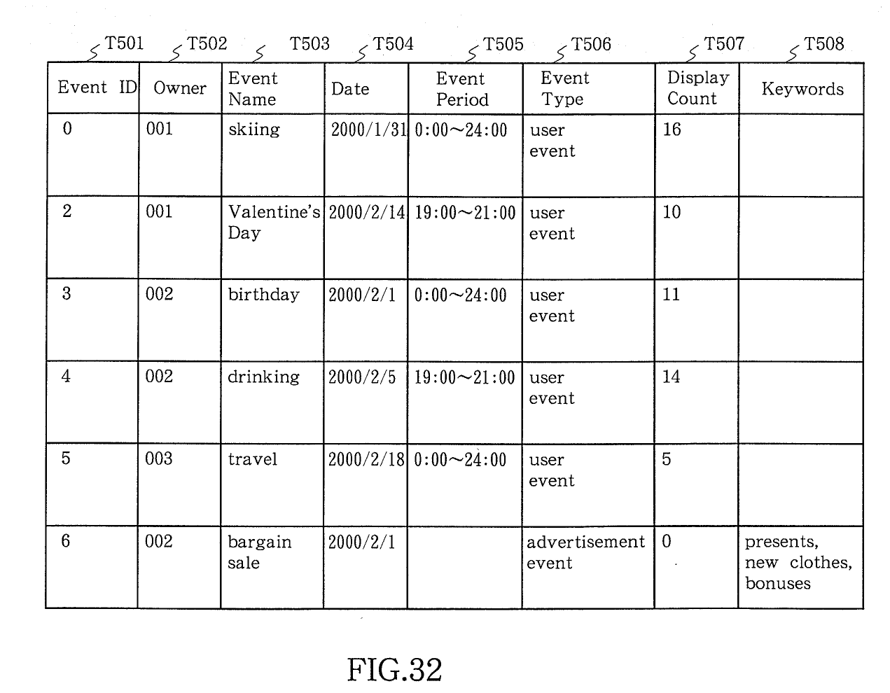

FIG. 32 shows the configuration of user schedule database 108 adapted to be able to store event advertisement keywords as well.

Keyword field T508 is only used by records of the advertisement event type, and is a field for storing keywords for each advertisement that an advertiser has input using advertisement input means 105. In step S60907 for registering an advertisement in user schedule database 108, advertisement scheduling means 114 stores, in this field (T508), the value of the keyword field (T804) in user advertisement database 113.

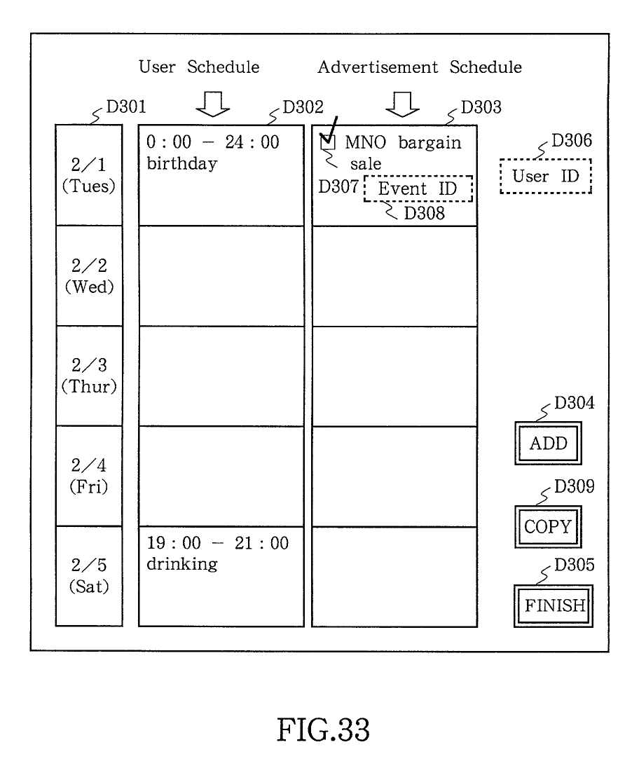

FIG. 33 shows an example of a screen of schedule input/output means 107 that has been adapted to permit the operation of copying an event advertisement displayed in D303 on the screen of schedule input/output means 107, to the user schedule displayed in D302.

In this third embodiment, a check box (D307) is displayed in front of each event advertisement, which means that this event advertisement can be selected by clicking the check box with a mouse pointer.

The event identification number (D308) is the identification number of the event advertisement in question, and is stored in the HTML file for the display screen. This is done by schedule input/output means 107, which, when it displays the screen, stores within the screen the value of the event identification number (T501) in the user schedule database.

COPY button (D309) is a button for copying an event advertisement whose check box has been checked, into the user's own schedule. When this button is clicked, schedule input/output means 107 sends, to advertisement copying means 116, all the values of the event identification numbers (D308) of the event advertisements that have been checked (107116).

When advertisement copying means 116 receives these event identification numbers from schedule input/output means 107, it uses, for each event identification number, the value of the received event identification number as a key to search the event identification number (T501) field of user schedule database 108, and changes the value of the advertisement type field T506 from “advertisement event” to “user event”.

As a result of thus changing the advertisement type (T506) from advertisement event to user event, the advertisement can no longer be deleted in step S60906 carried out by advertisement scheduling means 114 to delete an advertisement. In other words, when the advertisement is subsequently displayed, the copied advertisement is displayed in user schedule region D302 of schedule input/output means 107, and the user can refer to it at any time.

Next, a description will be given of how current interest estimation means 110 estimates user interests from copied event advertisements.

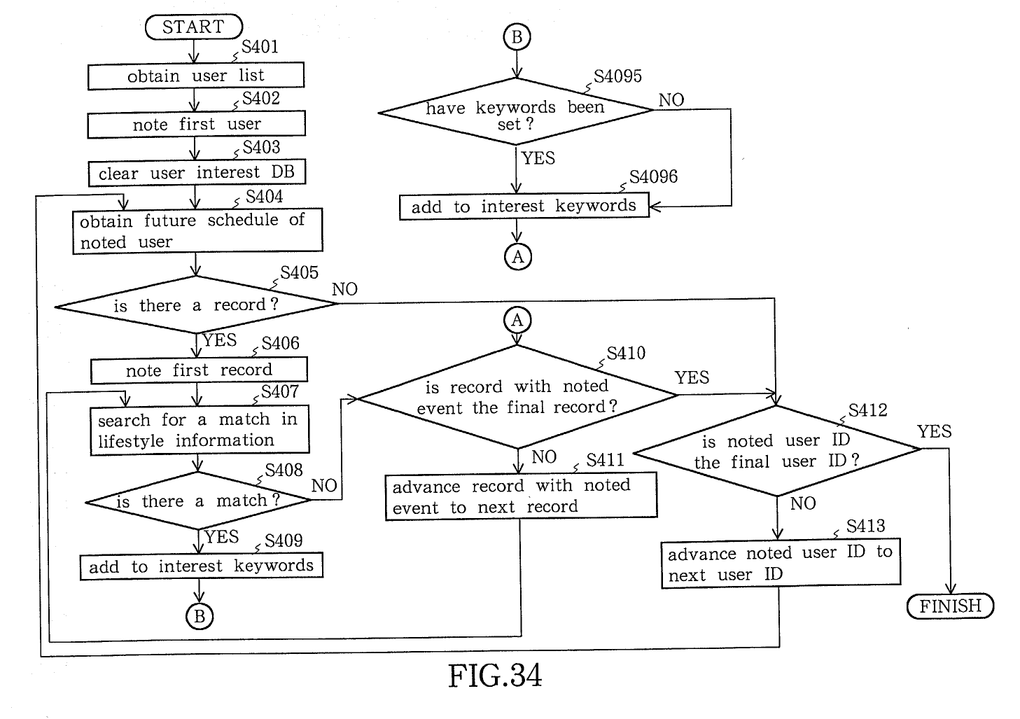

FIG. 34 shows a flowchart of this interest estimation process. This process flow comprises the following steps added after step S409 in the interest estimation processing flow depicted in FIG. 15.

Step S4095

If the value of the keywords field T508 of a noted event has been set, the flow advances to step S4096. If there are no keywords, the flow advances to step S410.

Step S4096

Using the same method as in step S409, current interest estimation means 110 registers, in user interest database 111, the value of the keyword field (T508) of the noted event.

The configuration described above enables keywords expressing the contents of an event advertisement that a user has copied, to be registered as user interests, so that subsequently, similar advertisements can be distributed by advertisement distribution means 112. This configuration also enables this invention to distribute advertisements that are in accord with users' interests, and therefore enables advertisements to be distributed to more suitable users. As a result, advertisers can anticipate more effective advertising.

More effective advertising can also be anticipated because advertisements suited not just to user interests but also to user location can be distributed. Moreover, a user can incorporate advertisements into his own schedule information, and advertisements can be distributed on the basis of estimating the user's interests from these incorporated advertisements. As a result, advertisements that the user would like to get can be distributed on subsequent occasions, and hence more effective advertising can be expected.

Furthermore, because an advertiser receives, as feedback, information relating to users to whom advertisements were distributed, the advertiser is able to evaluate the effect of his advertising.

What is claimed is:

1. An advertisement presentation system comprising:
user schedule information storage means for storing user schedule information;
advertisement data storage means for storing advertisements to be presented in conjunction with schedule information when a user consults his schedule information;
interest estimation means for estimating, from the user schedule information stored in the user schedule information storage means, which advertisements a user will be interested in; and
advertisement presentation means for presenting to a user, along with the user's schedule information, advertisements that the interest estimation means has estimated will be interesting to the user.

2. An advertisement presentation system according to claim 1, wherein:
the interest estimation means includes means for consulting a knowledge database in which has been stored information relating to what sort of advertising service a certain schedule item corresponds with, and for extracting, from the user's schedule information, a keyword for retrieving the associated advertisement data; and
the advertisement presentation means includes means for using the keyword extracted by the interest estimation means to associate advertisement data that matches the keyword with user schedule information, and for presenting this advertisement data along with the user schedule information.

3. An advertisement presentation system according to claim 1, wherein:
the advertisement data storage means stores geographical region data serving as a condition for presenting an advertisement;
a user whereabouts estimation means is provided for estimating, from the user's schedule information in the user schedule information storage means, which geographical region the user is currently in; and
the advertisement presentation means includes means for associating advertisement data that corresponds to this estimated user whereabouts with a user's schedule information, and for presenting the advertisement data along with the schedule information.

4. An advertisement presentation system according to claim 1, which includes means for storing as user schedule information in the user schedule storage means, as a result of user input, advertisement data that has been presented along with user schedule information;
wherein the interest estimation means includes means for estimating, from this advertisement data stored as schedule information, which advertisements the user will find interesting.

5. A server to which user terminals are connected via a network, this server comprising:
user schedule information storage means for storing user schedule information that has been input from the user terminals;
schedule output means for outputting user schedule information from the aforementioned user schedule information storage means when there has been an access from a user terminal;
advertisement data storage means for storing advertisement data that has been input from an advertising provider; and
means for associating the advertisement data stored in this advertisement data storage means with the user schedule information from the user schedule information storage means;
wherein:
the means for establishing this association includes interest estimation means for estimating, from the contents of the user schedule information, which advertisements the user will be interested in;
this interest estimation means includes means for consulting a database in which has been stored information relating to what sort of advertising service a particular schedule item corresponds with, and for extracting a keyword serving to extract advertisement data that corresponds with the stored user schedule information; and
there is provided advertisement presentation means which uses the keyword extracted by the interest estimation means to associate advertisement data that matches the keyword with the aforementioned user schedule information, and which presents the advertisement data in question along with the user schedule information.

6. A server according to claim 5, wherein:
the advertisement data storage means stores geographical region data serving as a condition for presenting an advertisement;
a user whereabouts estimation means is provided for estimating, from the user's schedule information in the user schedule information storage means, which geographical region the user is currently in; and
the advertisement presentation means includes means for associating advertisement data that corresponds with this estimated user whereabouts with a user's schedule information, and for presenting the advertisement data along with the schedule information.

7. A server according to claim 5 or 6, which includes means for storing as user schedule information in the user schedule storage means, as a result of user input, advertisement data that has been presented along with user schedule information.

8. User operable terminal equipment connected via a network to a server equipped with user schedule information storage means in which user schedule information can be stored, and with advertisement data storage means in which advertisement data has been stored; this terminal equipment comprising:
schedule information input means for inputting user schedule information to the user schedule information storage means; and
display means whereby, as a result of user control, the schedule information storage means is consulted, and the schedule information of the user in question is acquired and displayed;
wherein:
the display means comprises means for displaying, along with the acquired user schedule information, advertisement data stored in the advertisement data storage means of the server, said displayed advertisement data being that for which advertisement information associated with the user schedule information has been distributed along with the schedule information; and
the advertisement data to be distributed along with this schedule information is advertisement data indicated by an advertisement item estimated to be of interest to the user on the basis of the input user schedule information.

9. A storage medium in which have been stored programs which, by being installed in an information processing unit, implement the schedule and advertisement presentation system set forth in claims 1 to 4, the server set forth in claims 5 to 7, and the terminal equipment set forth in claim 8.
